(19) United States
(12) Patent Application Publication
(10) Pub. No.: US 2026/0222261 A1
(43) Pub. Date: Jul. 30, 2026

(54) COMMUNICATION METHOD, APPARATUS, AND SYSTEM

(71) Applicant: HUAWEI TECHNOLOGIES CO., LTD., Shenzhen,Guangdong (CN)

(72) Inventors: Chenglong Jiang, Shanghai (CN); Xiaoyan Bi, Shanghai (CN); Jianglei Ma, Ottawa (CA)

(21) Appl. No.: 19/575,179

(22) Filed: Mar. 23, 2026

Related U.S. Application Data
(63) Continuation of application No. PCT/CN2023/121629, filed on Sep. 26, 2023.

(51) Int. Cl. H04L 27/26; H04L 1/00; H04W 72/0453

(52) U.S. Cl. CPC H04L 27/261; H04L 1/0003; H04W 72/0453

(57) ABSTRACT

A communication method includes obtaining first information, determining, based on frequency domain density offset of a reference signal corresponding to M ports, a frequency domain density of the reference signal corresponding to the M ports, and sending or receiving the reference signal based on the frequency domain density of the reference signal corresponding to the M ports. The first information is useable to determine the frequency domain density offset of the reference signal corresponding to the M ports. M is a positive integer.

### CROSS-REFERENCE TO RELATED APPLICATIONS

The present application is a continuation of International Application No. PCT/CN2023/121629, filed on Sep. 26, 2023, the disclosure of which is hereby incorporated by reference in its entirety.

### TECHNICAL FIELD

The present application relates to the field of communication technologies, and in particular, to a communication method, apparatus, and system.

### BACKGROUND

In massive (massive) multiple-input multiple-output (MIMO), importance of estimating an uplink channel or a downlink channel is increasingly evident for sending and receiving data, obtaining system synchronization, and feeding back channel information. Channel estimation is a process of reconstructing or restoring a received signal to compensate for signal distortion caused by channel fading and noise-induced attenuation, and tracks changes of a channel in time domain and frequency domain by using standard signals predicted by a transmitter and a receiver. The standard signals are also referred to as pilot signals or reference signals (RS). The standard signals are distributed on different resource elements (RE) in two-dimensional time-frequency space of an orthogonal frequency division multiplexing (OFDM) symbol (symbol), and have known amplitudes and phases.

One of the reference signals is a demodulation reference signal (DMRS). User equipment (UE) performs channel estimation based on a received DMRS, and an obtained channel estimation result may be used to assist in demodulation of a physical downlink shared channel (PDSCH). Performance of channel estimation based on the DMRS is affected by factors such as a signal-to-noise ratio and a frequency domain density of a DMRS port. Therefore, performance of channel estimation is poor.

### SUMMARY

One or more embodiments of the present application provide a communication method, apparatus, and system, to improve channel estimation accuracy.

According to a first aspect, a first communication method is provided. The method may be performed by a terminal device, or may be performed by a chip system. The chip system can implement a function of the terminal device. The method includes: obtaining first information, where the first information is used to determine a frequency domain density offset of a reference signal corresponding to M ports, and M is a positive integer; determining, based on the frequency domain density offset of the reference signal corresponding to the M ports, a frequency domain density of the reference signal corresponding to the M ports; and sending or receiving the reference signal based on the frequency domain density of the reference signal corresponding to the M ports.

In some embodiments of this application, the frequency domain density offset of the reference signal corresponding to the M ports may be determined based on the first information. For example, frequency domain density offsets of reference signals corresponding to different ports are the same or different. Therefore, frequency domain densities of the reference signals corresponding to the different ports can be separately adjusted, so that the frequency domain densities of reference signals corresponding to the ports can match factors such as channel conditions of the ports. When channel estimation is performed based on a DMRS, channel estimation may be performed based on a frequency domain density of a reference signal corresponding to a corresponding port. This is equivalent to that a channel condition corresponding to the port is considered in a channel estimation process, so that the channel estimation process can adapt to various different channel conditions, thereby helping improve channel estimation accuracy.

In some embodiments, obtaining the first information includes: receiving the first information from a network device; or obtaining the predefined first information. The first information may be from a network device, or may be predefined in a protocol, or may be preconfigured in a terminal device and the network device, or may be determined by the terminal device and the network device through negotiation. This is not specifically limited.

In some embodiments, the first information indicates a mapping relationship between different modulation and coding schemes (MCS) and frequency domain density offsets of reference signals corresponding to different ports. The terminal device may determine the frequency domain density offset of each of the M ports based on the first information, and the network device does not need to send the determined frequency domain density offset to the terminal device, thereby simplifying implementation of the network device.

In some embodiments, the mapping relationship includes a mapping relationship between at least one MCS interval, at least one frequency domain density offset, and indexes of N ports, an index of each of the N ports corresponds to the at least one MCS interval, in MCS intervals and frequency domain density offsets corresponding to one of the N ports, different MCS intervals correspond to a same frequency domain density offset or different frequency domain density offsets, and in port indexes and frequency domain density offsets corresponding to one of the at least one MCS interval, different port indexes correspond to a same frequency domain density offset or different frequency domain density offsets; and the N ports include the M ports. The mapping relationship may also meet the following: In the mapping relationship, each of the N ports (or each port index) may correspond to a plurality of MCS intervals (the plurality of MCS intervals are, for example, a part of or all of the at least one MCS interval). In each port, each of the plurality of MCS intervals corresponds to one frequency domain density offset, and different MCS intervals correspond to a same frequency domain density offset or different frequency domain density offsets; and/or each of the at least one MCS interval may correspond to a plurality of ports (or correspond to a plurality of port indexes. The plurality of ports are, for example, a part of or all of the N ports). In each MCS interval, each port (or each port index) in the plurality of ports corresponds to one frequency domain density offset, and different ports correspond to a same frequency domain density offset or different frequency domain density offsets. The mapping relationship may cover a large quantity of ports. For example, the N ports are all or a part of ports corresponding to the terminal device and the network device. Alternatively, in addition to all or a part of ports corresponding to the terminal device and the network device, the N ports may further include all or a part of ports corresponding to another terminal device and/or another network device. In the first information, one or more MCS intervals may correspond to one frequency domain density offset, and one of the MCS intervals may include one or more values of the MCS. This can simplify the mapping relationship and reduce storage space occupied by the mapping relationship.

In some embodiments, the first information indicates a mapping relationship between different MCSs and frequency domain density offsets of reference signals corresponding to different port groups, and one port group includes one or more ports in the M ports. The terminal device may determine the frequency domain density offset of each of the M ports based on the first information, and the network device does not need to send the determined frequency domain density offset to the terminal device, thereby simplifying implementation of the network device. In addition, the port or the port group may have a mapping relationship with the frequency domain density offset. For example, ports in one port group have a same feature or similar features (for example, similar channel conditions). In this case, the port group may have a mapping relationship with the frequency domain density offset as a whole, thereby simplifying the mapping relationship.

In some embodiments, the mapping relationship includes a mapping relationship between at least one MCS interval, at least one frequency domain density offset, and an index of at least one port group, an index of each of the at least one port group corresponds to the at least one MCS interval, in MCS intervals and frequency domain density offsets corresponding to one of the at least one port group, different MCS intervals correspond to a same frequency domain density offset or different frequency domain density offsets, and in port group indexes and frequency domain density offsets corresponding to one of the at least one MCS interval, different port group indexes correspond to a same frequency domain density offset or different frequency domain density offsets; and the at least one port group includes N ports, and the N ports include the M ports. The mapping relationship may also meet the following: In the mapping relationship, each port group (or each port group index) in the at least one port group may correspond to a plurality of MCS intervals (the plurality of MCS intervals are, for example, a part of or all of the at least one MCS interval). In each port group, each of the plurality of MCS intervals corresponds to one frequency domain density offset, and different MCS intervals correspond to a same frequency domain density offset or different frequency domain density offsets; and/or each of the at least one MCS interval may correspond to a plurality of port groups (or correspond to a plurality of port group indexes, and the plurality of port groups are, for example, a part of or all of the at least one port group). In each MCS interval, each port group (or each port group index) in the plurality of ports corresponds to one frequency domain density offset, and different port groups correspond to a same frequency domain density offset or different frequency domain density offsets.

In some embodiments, for a same port in the N ports, a larger MCS corresponding to the port indicates a larger frequency domain density offset (or frequency domain density) of a reference signal corresponding to the port; or a smaller MCS corresponding to the port indicates a smaller frequency domain density offset (or frequency domain density) of a reference signal corresponding to the port. This is only one relationship between the MCS and the frequency domain density offset of the reference signal, and is not specifically limited thereto.

In some embodiments, a sum of frequency domain density offsets of reference signals corresponding to the N ports is less than or equal to a first threshold, and the N ports include the M ports. Optionally, the first threshold is 0, that is, the sum of the frequency domain density offsets of the reference signals corresponding to the N ports is 0, indicating that overall overheads of the reference signal does not need to change before and after the frequency domain density is adjusted. In this case, channel estimation accuracy can be improved in some embodiments of this application without increasing the overheads of the reference signal.

In some embodiments, the method further includes: receiving downlink control information from the network device, where the downlink control information indicates one or more MCSs, and the one or more MCSs correspond to the M ports; and determining, based on the one or more MCSs and the mapping relationship indicated by the first information, frequency domain density offsets of reference signals corresponding to a part or all of the M ports. This implementation provides a specific manner in which the terminal device determines the frequency domain density offset (or the frequency domain density). To be specific, the terminal device can determine, with reference to the first information and the MCS indicated by the downlink control information, the frequency domain density offset corresponding to the part or all of the M ports, so that the terminal device can further determine the frequency domain density of the reference signal corresponding to the part or all of the M ports.

In some embodiments, the first information indicates a frequency domain density of a reference signal corresponding to each of the M ports; or the first information indicates a frequency domain density offset of a reference signal corresponding to each of the M ports. In the foregoing solution, the first information may indicate the mapping relationship between the MCS and the frequency domain density offset of the reference signal, and the terminal device determines the frequency domain density of the reference signal corresponding to the part or all of the M ports. In this implementation, the frequency domain density or the frequency domain density offset of the reference signal corresponding to the part or all of the M ports may be determined by the network device. The network device may send the determined frequency domain density or frequency domain density offset to the terminal device, so that the terminal device does not need to perform a determining step, thereby simplifying implementation of the terminal device, and also more facilitating that final frequency domain densities determined by the terminal device and the network device are consistent.

In some embodiments, the first information further indicates a frequency domain resource location to which the reference signal corresponding to each of the M ports is mapped; or a frequency domain resource location to which the reference signal corresponding to each of the M ports is mapped is predefined. In some embodiments of this application, the frequency domain density of the reference signal corresponding to the part or all of the M ports is adjusted. After a frequency domain density of the reference signal corresponding to one port changes, a frequency domain resource location of the reference signal corresponding to the port may also change. In this case, the first information may indicate the changed frequency domain resource location, and the frequency domain resource to which the reference signal is mapped may be flexible. Alternatively, the frequency domain resource location to which the reference signal corresponding to each of the M ports is mapped may be predefined by a protocol, or may be preconfigured by the network device. Therefore, overheads of the first information can be reduced.

In some embodiments, the method further includes: sending capability information of the terminal device to the network device, where the capability information indicates whether the terminal device supports adjustment of frequency domain densities of the M ports, or the capability information indicates a maximum value and a minimum value of a frequency domain density offset supported by each of the M ports. The terminal device may send the capability information to the network device, so that frequency domain density adjustment can match a capability or a requirement of the terminal device.

In some embodiments, a difference between a first frequency domain density and a second frequency domain density is less than or equal to a second threshold, the first frequency domain density is a sum of frequency domain densities corresponding to the M ports that is determined based on the frequency domain density offset of the reference signal corresponding to the M ports, and the second frequency domain density is a sum of initial frequency domain densities corresponding to the M ports. Optionally, if the second threshold is 0, the difference between the first frequency domain density and the second frequency domain density may be 0, indicating that the overall overheads of the reference signal does not change. In this case, channel estimation accuracy can be improved in some embodiments of this application without increasing the overheads of the reference signal.

In some embodiments, when the first frequency domain density is less than the second frequency domain density, the method further includes: sending or receiving data by using a first reference signal resource, where the first reference signal resource is a reference signal resource corresponding to a difference between the second frequency domain density and the first frequency domain density. The first frequency domain density is less than the second frequency domain density, indicating that the overall frequency domain density is reduced after the frequency domain density of the reference signal corresponding to the part or all of the M ports is adjusted. Therefore, a part of resources (for example, referred to as a first reference signal resource, and may be understood as a resource corresponding to an absolute value of a difference between the first frequency domain density and the second frequency domain density) that are originally used to send the reference signal are no longer used to send the reference signal. In this case, the terminal device may send or receive data by using the first reference signal resource, to improve resource utilization.

According to a second aspect, a second communication method is provided. The method may be performed by a network device, or may be performed by a chip system. The chip system can implement a function of the network device. The method includes: determining, based on a frequency domain density offset of a reference signal corresponding to M ports, a frequency domain density of the reference signal corresponding to the M ports, where M is a positive integer; and receiving or sending the reference signal based on the frequency domain density of the reference signal corresponding to the M ports.

In some embodiments, the method further includes: obtaining the predefined first information; or sending first information to a terminal device, where the first information is used to determine the frequency domain density offset of the reference signal corresponding to the M ports.

In some embodiments, the first information indicates a mapping relationship between different MCSs and frequency domain density offsets of reference signals corresponding to different ports.

In some embodiments, the mapping relationship includes a mapping relationship between at least one MCS interval, at least one frequency domain density offset, and indexes of N ports, an index of each of the N ports corresponds to the at least one MCS interval, in MCS intervals and frequency domain density offsets corresponding to one of the N ports, different MCS intervals correspond to a same frequency domain density offset or different frequency domain density offsets, and in port indexes and frequency domain density offsets corresponding to one of the at least one MCS interval, different port indexes correspond to a same frequency domain density offset or different frequency domain density offsets; and the N ports include the M ports.

In some embodiments, the first information indicates a mapping relationship between different MCSs and frequency domain density offsets of reference signals corresponding to different port groups, and one port group includes one or more ports in the M ports.

In some embodiments, the mapping relationship includes a mapping relationship between at least one MCS interval, at least one frequency domain density offset, and an index of at least one port group, an index of each of the at least one port group corresponds to the at least one MCS interval, in MCS intervals and frequency domain density offsets corresponding to one of the at least one port group, different MCS intervals correspond to a same frequency domain density offset or different frequency domain density offsets, and in port group indexes and frequency domain density offsets corresponding to one of the at least one MCS interval, different port group indexes correspond to a same frequency domain density offset or different frequency domain density offsets; and the at least one port group includes N ports, and the N ports include the M ports.

In some embodiments, for a same port in the N ports, a larger MCS corresponding to the port indicates a larger frequency domain density offset of a reference signal corresponding to the port; or a smaller MCS corresponding to the port indicates a smaller frequency domain density offset of a reference signal corresponding to the port.

In some embodiments, a sum of frequency domain density offsets of reference signals corresponding to the N ports is less than a first threshold, and the N ports include the M ports.

In some embodiments, the method further includes: sending downlink control information to the terminal device, where the downlink control information indicates one or more MCSs, the one or more MCSs correspond to the M ports, and the one or more MCSs and the mapping relationship indicated by the first information are used to determine frequency domain density offsets of reference signals corresponding to a part or all of the M ports.

In some embodiments, the first information indicates a frequency domain density of a reference signal corresponding to each of the M ports; or the first information indicates a frequency domain density offset of a reference signal corresponding to each of the M ports.

In some embodiments, the first information further indicates a frequency domain resource location to which the reference signal corresponding to each of the M ports is mapped; or a frequency domain resource location to which the reference signal corresponding to each of the M ports is mapped is predefined.

In some embodiments, the method further includes: receiving capability information from the terminal device, where the capability information indicates whether the terminal device supports adjustment of frequency domain densities of the M ports, or the capability information indicates a maximum value and a minimum value of a frequency domain density offset supported by each of the M ports.

In some embodiments, a difference between the first frequency domain density and the second frequency domain density is less than a second threshold, the first frequency domain density is a sum of frequency domain densities corresponding to the M ports that is determined based on the frequency domain density offset of the reference signal corresponding to the M ports, and the second frequency domain density is a sum of initial frequency domain densities corresponding to the M ports.

In some embodiments, when the first frequency domain density is less than the second frequency domain density, the method further includes: receiving or sending data by using a first reference signal resource, where the first reference signal resource is a reference signal resource corresponding to a difference between the second frequency domain density and the first frequency domain density.

For technical effects brought by the second aspect or some optional implementations, refer to descriptions of technical effects brought by the first aspect or the corresponding embodiments.

According to a third aspect, a communication apparatus is provided. The communication apparatus has a function of implementing behavior in the method embodiment in any one of the first aspect and the second aspect. For beneficial effect, refer to the foregoing descriptions. Details are not described herein again.

The communication apparatus may implement a function of the terminal device in any one of the first aspect and the second aspect. For example, the communication apparatus is the terminal device in any one of the first aspect and the second aspect, or is an electronic device (for example, a chip system) configured in the terminal device, or is a larger device including the terminal device. The terminal device includes corresponding means (means) or modules for performing the foregoing method. Alternatively, the communication apparatus may implement a function of the network device in any one of the first aspect and the second aspect. For example, the communication apparatus may be the network device in any one of the first aspect and the second aspect, or may be an electronic device (for example, a chip system) configured in the network device, or may be a larger device including the network device. The network device includes corresponding means or modules for performing the foregoing method. For example, the communication apparatus includes a processing unit (or referred to as a processing module) and a transceiver unit (or referred to as a transceiver module).

When the communication apparatus can implement the function of the terminal device according to any one of the first aspect and the second aspect, in an example, the processing unit is configured to obtain first information, where the first information is used to determine a frequency domain density offset of a reference signal corresponding to M ports, and M is a positive integer; and the processing unit is further configured to determine, based on the frequency domain density offset of the reference signal corresponding to the M ports, a frequency domain density of the reference signal corresponding to the M ports; and the transceiver unit is configured to send or receive the reference signal based on the frequency domain density of the reference signal corresponding to the M ports.

When the communication apparatus can implement the function of the network device according to any one of the first aspect and the second aspect, in an example, the processing unit is configured to determine, based on the frequency domain density offset of the reference signal corresponding to M ports, the frequency domain density of the reference signal corresponding to the M ports, where M is a positive integer; and the transceiver unit is configured to receive or send the reference signal based on the frequency domain density of the reference signal corresponding to the M ports.

In some embodiments, the communication apparatus includes a storage unit. The processing unit can be coupled to the storage unit, and execute a program or instructions in the storage unit, to enable the communication apparatus to perform a function of the terminal device or the network device.

In some embodiments, the communication apparatus includes a processor, coupled to a memory, and configured to execute instructions in the memory, to implement the method performed by the terminal device or the network device according to any one of the first aspect and the second aspect. Optionally, the communication apparatus further includes other components, for example, an antenna, an input/output module, and an interface. Such components may be hardware, software, or a combination of software and hardware.

According to a fourth aspect, a communication apparatus is provided. The communication apparatus may be a terminal device, or may be a chip or a chip system used in a terminal device. Alternatively, the communication apparatus may be a network device, or a chip or a chip system used in a network device. The communication apparatus includes a communication interface and a processor, and optionally, further includes a memory. Optionally, the communication interface includes a transmit port and/or a receiving port; or optionally, the communication interface is a transceiver, and the transceiver may implement a sending function and/or a receiving function. The memory is configured to store a computer program. The processor is coupled to the memory and the communication interface. When the processor reads the computer program or the instructions, the communication apparatus is enabled to perform the method performed by the terminal device or the network device in any one of the first aspect and the second aspect.

According to a fifth aspect, a communication apparatus is provided. The communication apparatus may be a terminal device, or may be a chip or a chip system used in the terminal device. Alternatively, the communication apparatus may be a network device, or a chip or a chip system used in a network device. The communication apparatus includes a processor, and optionally, further includes a memory. The memory is configured to store a computer program. The processor is coupled to the memory and the communication interface. When the processor reads the computer program or the instructions, the communication apparatus is enabled to perform the method performed by the terminal device or the network device in any one of the first aspect and the second aspect. Optionally, the communication apparatus further includes a communication interface. Optionally, the communication interface includes a sending port and/or a receiving port. Optionally, the communication interface is a transceiver, and the transceiver may implement a sending function and/or a receiving function.

According to a sixth aspect, a computer-readable storage medium is provided. The computer-readable storage medium is configured to store a computer program. When the computer program is run on a computer, the computer is enabled to perform the method according to any one of the first aspect and the second aspect.

According to a seventh aspect, a computer program product is provided. The computer program product includes a computer program. When the computer program is run on a computer, the computer is enabled to perform the method according to any one of the first aspect and the second aspect.

According to an eighth aspect, a chip system is provided, including a processor and an interface. The processor is configured to invoke instructions from the interface and run the instructions. When the processor executes the instructions, the method according to any one of the first aspect and the second aspect is implemented.

According to a ninth aspect, a communication system is provided, including a terminal device and a network device. The terminal device may implement the method performed by the terminal device in any one of the first aspect or the second aspect, and the network device may implement the method performed by the network device in any one of the first aspect or the second aspect. Optionally, the terminal device may be implemented by using the communication apparatus according to the third aspect or the fourth aspect, and the network device may be implemented by using the communication apparatus according to the third aspect or the fourth aspect.

### BRIEF DESCRIPTION OF DRAWINGS

FIG. 1A and FIG. 1B are diagrams of two types of NR DMRSs;

FIG. 2 is a diagram of a communication network architecture to which embodiments of this application are applied;

FIG. 3 is a schematic flowchart of a communication method according to an embodiment of this application;

FIG. 4A is a diagram of a relationship between a frequency domain density of a reference signal and an MCS at a specific port according to an embodiment of this application;

FIG. 4B is a diagram of a maximum MCS changing with a frequency domain density of a reference signal at a specific port or port group according to an embodiment of this application;

FIG. 5A is a frequency domain resource location to which a reference signal is mapped when a frequency domain density of the reference signal corresponding to M ports is an initial frequency domain density according to an embodiment of this application;

FIG. 5B is a frequency domain resource location to which a reference signal is mapped when a frequency domain density of the reference signal corresponding to M ports is an adjusted frequency domain density according to an embodiment of this application;

FIG. 6 is a diagram of a relationship between interpolation filtering performance of a Wiener filter and a frequency domain density of a reference signal;

FIG. 7 is a diagram of an apparatus according to an embodiment of this application; and

FIG. 8 is a diagram of another apparatus according to an embodiment of this application.

### DETAILED DESCRIPTION

To make objectives, technical solution, and advantages of embodiments of this application clearer, the following further describes embodiments of this application in detail with reference to the accompanying drawings.

In embodiments of this application, unless otherwise specified, a quantity of nouns represents “a singular noun or a plural noun”, that is, “one or more”. “At least one” means one or more, and “a plurality of” means two or more. “And/or” describes an association relationship between associated objects, and indicates that three relationships may exist. For example, A and/or B may indicate the following cases: Only A exists, both A and B exist, and only B exists, where A and B may be singular or plural. The character “/” generally indicates an “or” relationship between the associated objects. For example, A/B indicates A or B. “At least one of the following items (pieces)” or a similar expression thereof refers to any combination of these items, including any combination of singular items (pieces) or plural items (pieces). For example, at least one item (piece) of a, b, or c indicates a, b, c, a and b, a and c, b and c, or a, b, and c, where a, b, and c may be singular or plural.

Ordinal numbers such as “first” and “second” in embodiments of this application are intended to distinguish between a plurality of objects, but are not intended to limit sizes, content, an order, a time sequence, priorities, importance degrees, or the like of the plurality of objects. For example, a first frequency domain density and a second frequency domain density may be a same frequency domain density, or may be different frequency domain densities. In addition, such names do not indicate that reference signals, ports, application scenarios, priorities, or importance degrees corresponding to the two frequency domain densities are different. In addition, step numbers in embodiments described in this application are merely intended to distinguish between different steps, but are not intended to limit a sequence of the steps. For example, S302 may be performed before S303, or may be performed after S303, or may be performed simultaneously with S303.

The following describes some terms or concepts in embodiments of this application, to facilitate understanding of a person skilled in the art.

In embodiments of this application, a terminal device is a device having a wireless transceiver function, and may be a fixed device, a mobile device, a handheld device (for example, a mobile phone), a wearable device, a vehicle-mounted device, or a wireless apparatus (for example, a communication module, a modem, or a chip system) built in the foregoing device. The terminal device is configured to connect people, things, machines, and the like, and may be widely used in various scenarios. For example, the terminal device includes but is not limited to terminal devices in the following scenarios: a sensing scenario, cellular communication, device-to-device (D2D) communication, vehicle to everything (V2X), machine-to-machine/machine-type communication (M2M/MTC), an internet of things (IoT), virtual reality (VR), augmented reality (AR), industrial control (industrial control), self driving (self driving), telemedicine (remote medical), a smart grid (smart grid), smart furniture, a smart office, a smart wearable, smart transportation, a smart city (smart city), an uncrewed aerial vehicle, a robot, and the like. The terminal device may sometimes be referred to as a UE, a terminal, an access station, a UE station, a remote station, a wireless communication device, a user apparatus, or the like.

In embodiments of this application, a communication apparatus configured to implement a function of the terminal device may be the terminal device, or may be an apparatus, for example, a chip system, that can support the terminal device in implementing the function. The apparatus may be mounted in the terminal device. In the technical solutions provided in embodiments of this application, an example in which the apparatus configured to implement the function of the terminal device is a terminal device is used to describe the technical solutions provided in embodiments of this application. In addition, for ease of description, an example in which the terminal device is UE is used for description in embodiments of this application.

A network device in embodiments of this application includes, for example, an access network device and/or a core network device. The access network device is a device having a wireless transceiver function, and is configured to communicate with the terminal device. The access network device includes but is not limited to a base station (a base transceiver station (BTS), a NodeB (NodeB), an evolved NodeB (evolved NodeB, eNodeB)/eNB, or a next-generation NodeB (gNodeB)/gNB), a transmission reception point (TRP), a subsequently evolved base station in the 3rd generation partnership project (3GPP), an access node in a wireless fidelity (Wi-Fi) system, a wireless relay node, a wireless backhaul node, and the like. The base station may be a macro base station, a micro base station, a picocell base station, a small cell, a relay station, or the like. A plurality of base stations may support networks using a same access technology, or may support networks using different access technologies. The base station may include one or more co-site or non-co-site transmission reception points. Alternatively, the access network device may be a radio controller in a cloud radio access network (CRAN) scenario, a central unit (CU), and/or a distributed unit (DU). Alternatively, the access network device may be a server or the like. For example, a network device in a V2X technology may be a road side unit (RSU). The following uses an example in which the access network device is a base station for description. The base station may communicate with the terminal device, or may communicate with the terminal device via a relay station. The terminal device may communicate with the plurality of base stations in different access technologies. The core network device is configured to implement functions such as mobility management, data processing, session management, and policy and charging. Names of devices that implement core network functions in systems of different access technologies may be different. This is not limited in embodiments this application. A 5th generation (5G) mobile communication technology system is used as an example. The core network device includes an access and mobility management function (AMF), a session management function (SMF), a policy control function (PCF), a user plane function (UPF), or the like.

In a CU-DU architecture, the access network device may include one or more of logical network elements such as a central unit (CU), a distributed unit (DU), a CU-control plane (CP), a CU-user plane (UP), or a radio unit (RU). The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH).

In different systems, the CU (or the CU-CP and the CU-UP), the DU, or the RU may alternatively have different names, but a person skilled in the art may understand meanings thereof. For example, in an open radio access network (ORAN) system, the CU may also be referred to as an open (O)-CU, the DU may also be referred to as an O-DU, the CU-CP may also be referred to as an O-CU-CP, the CU-UP may also be referred to as an O-CU-UP, and the RU may also be referred to as an O-RU. For ease of description, in embodiments of this application, the CU, the CU-CP, the CU-UP, the DU, and the RU are used as examples for description. In embodiments of this application, any unit in the CU (or the CU-CP or the CU-UP), the DU, and the RU may be implemented by a software module, a hardware module, or a combination of a software module and a hardware module.

In embodiments of this application, a communication apparatus configured to implement a function of the network device may be a network device, or may be an apparatus, for example, a chip system, that can support the network device in implementing the function. The apparatus may be installed in the network device. In the technical solutions provided in embodiments of this application, an example in which the apparatus configured to implement the function of the network device is a network device is used to describe the technical solutions provided in embodiments of this application.

The following describes technical characteristics in embodiments of this application.

In massive MIMO, importance of estimating an uplink channel or a downlink channel is increasingly evident for sending and receiving data, obtaining system synchronization, and feeding back channel information. Channel estimation is a process of reconstructing or restoring a received signal to compensate for signal distortion caused by channel fading and noise-induced attenuation, and tracks changes of a channel in time domain and frequency domain by using standard signals predicted by a transmitter and a receiver. The standard signals are also referred to as pilot signals or reference signals. The standard signals are distributed on different subcarriers in frequency domain in an OFDM symbol, and have known amplitudes and phases. One of the reference signals is a DMRS. UE performs channel estimation based on the received DMRS, and an obtained channel estimation result may be used to assist in demodulation of a PDSCH.

Sparsification of time-frequency resources of reference signals is one of main means for implementing a larger quantity of transport streams.

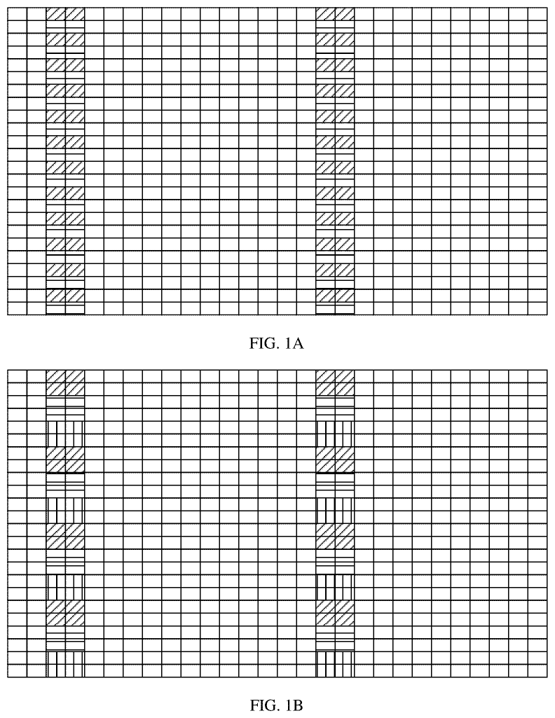

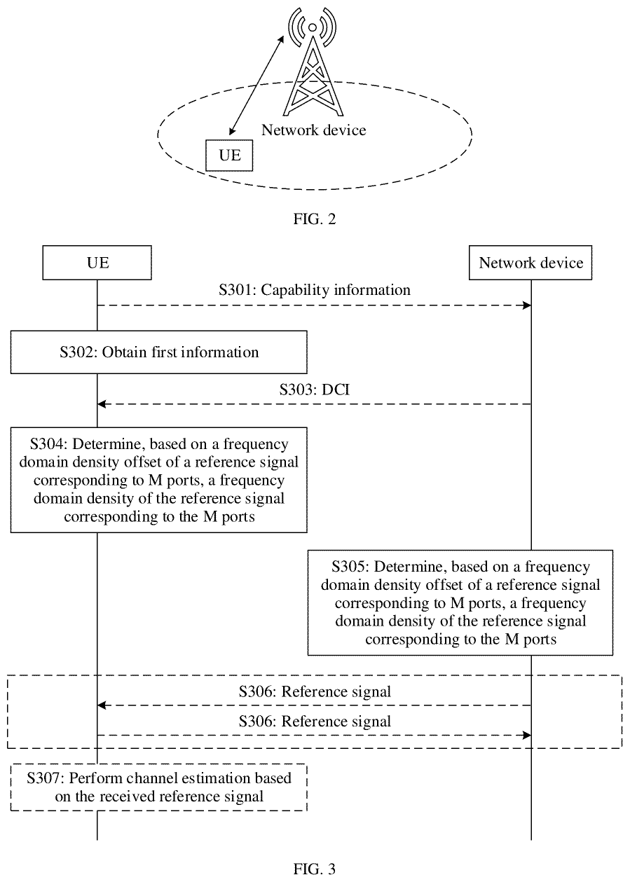

In the R15 version, new radio (NR) DMRS types, that is, Type (Type) I and Type II, support a maximum of eight DMRS ports (ports) and a maximum of 12 DMRS ports respectively, and corresponding frequency domain densities are respectively three REs per resource block (RB) and two REs per RB. Refer to FIG. 1A and FIG. 1B. FIG. 1A and FIG. 1B are respectively diagrams of Type I and Type II. In FIG. 1A and FIG. 1B, shadow boxes with different filling content represent different DMRS port groups. For example, FIG. 1A shows Type I that supports a maximum of eight DMRS ports, for example, supports four DMRS ports. The four DMRS ports may be divided into two DMRS port groups. Each DMRS port group includes two DMRS ports, and the two DMRS port groups are respectively shown by two shadow blocks with different filling in FIG. 1A. FIG. 1B shows Type II that supports a maximum of 12 DMRS ports, for example, supports 12 DMRS ports. The 12 DMRS ports may be divided into three DMRS port groups. Each DMRS port group includes four DMRS ports, and the three DMRS port groups are respectively shown by four shadow boxes with different filling in FIG. 1B. In FIG. 1A and FIG. 1B, a horizontal axis represents time, a vertical axis represents a frequency, and one block represents one RE including one OFDM symbol and one subcarrier.

DMRSs used to demodulate PDSCHs include the following features:
1. The DMRSs are classified into front-loaded (FL) DMRSs and add-on (Add-on) DMRSs. The FL DMRS occupies one or two OFDM symbols, for example, occupies an OFDM symbol 2 and an OFDM symbol 3 in a slot (slot). When the FL DMRS occupies two OFDM symbols, a quantity of OFDM symbols occupied by the add-on DMRS is 0 to 2. When the FL DMRS occupies one OFDM symbol, a quantity of OFDM symbols occupied by the add-on DMRS is 0 to 3.
2. The DMRS is mapped to each scheduling unit according to a rule, for example, the scheduling unit is a physical resource block (PRB) pair (pair). A DMRS sent on each DMRS port is mapped to each scheduled scheduling unit. In addition, the DMRS sent on each DMRS port is mapped to each scheduled slot.
3. DMRS PRB bundling (bundling). A plurality of consecutive PRBs are used as a bundle (bundle) or a precoding resource block group (PRG). A transmitter and a receiver may perform joint processing on the bundle or the PRG in frequency domain. This processing manner helps improve receiving performance.
4. DMRS rate matching (rate matching). A base station may indicate, to UE, DMRS ports that are occupied. Unoccupied DMRS ports may be used to transmit data.

Currently, DMRS eType I and eType II are being promoted. The two types of DMRSs support a maximum of 16 DMRS ports and a maximum of 24 DMRS ports respectively. Corresponding frequency domain densities are respectively three REs per two RBs and one RE per RB. It can be learned that frequency domain densities of eType I and eType II are halved relative to frequency domain densities of Type I and Type II. A same frequency domain density configuration is used for all DMRS ports. When reference signals become sparse in frequency domain, channel estimation accuracy is affected, and finally, spectral efficiency of massive MIMO may be reduced.

In view of this, in embodiments of this application, frequency domain density offsets of reference signals corresponding to M ports may be determined based on first information. For example, frequency domain density offsets of reference signals corresponding to different ports are the same or different. Therefore, frequency domain densities of the reference signals corresponding to the different ports can be separately adjusted, so that the frequency domain densities of the reference signals corresponding to the ports can match factors such as channel conditions of the ports. When channel estimation is performed based on a DMRS, channel estimation may be performed based on a frequency domain density of a reference signal corresponding to a corresponding port. This is equivalent to that a channel condition corresponding to the port is considered in a channel estimation process, so that the channel estimation process can adapt to various different channel conditions, thereby helping improve channel estimation accuracy.

The technical solutions provided in embodiments of this application may be applied to a 4th generation (4G) mobile communication technology system, for example, a long term evolution (LTE) system, may be applied to a 5th generation (5G) mobile communication technology system, for example, an NR system, or may be applied to a next generation mobile communication system or another similar communication system, for example, a 6th generation (6G) mobile communication technology system. This is not specifically limited. In addition, the technical solutions provided in embodiments of this application may be applied to a D2D scenario, for example, an NR-D2D scenario, or may be applied to a V2X scenario, for example, an NR-V2X scenario. For example, the technical solutions provided in embodiments of this application may be applied to a field like factory manufacturing, whole-house intelligence, intelligent driving, driving assistance, or an intelligent connected vehicle.

FIG. 2 is a communication network architecture to which embodiments of this application are applied. FIG. 2 includes UE and a network device. The network device may send a reference signal, or may receive a reference signal from the UE. The UE may receive a reference signal from the network device, or may send a reference signal to the network device. The UE and the network device can perform the methods provided in embodiments of this application.

To better describe embodiments of this application, the following describes, with reference to the accompanying drawings, methods provided in embodiments of this application. In embodiments of this application, a “port” may be a “reference signal port”. In embodiments of this application, the reference signal includes, for example, a DMRS or another reference signal, for example, a sounding reference signal (SRS). The DMRS may include an uplink DMRS or a downlink DMRS. Unless otherwise specified below, in the accompanying drawings corresponding to embodiments of this application, steps represented by dashed lines are all optional steps.

The methods provided in embodiments of this application may be applied to the network architecture shown in FIG. 2. For example, the UE in embodiments of this application may be the UE in FIG. 2. The network device in embodiments of this application may be the network device in FIG. 2.

An embodiment of this application provides a communication method. FIG. 3 is a flowchart of the method.

S301: UE sends capability information of the UE to a network device. Correspondingly, the network device receives the capability information of the UE.

Optionally, the network device may be an entire architecture, or may be a distributed architecture. For example, the network device includes a CU and/or a DU, or includes one or more of a CU-CP, a CU-UP, or a DU. When the network device includes the DU, that the network device receives the capability information from the UE may be specifically that the DU included in the network device receives the capability information from the UE. Optionally, the network device including the DU may further include the CU; or the network device including the DU may further include the CU-CP and/or the CU-UP.

The capability information of the UE may indicate a channel processing capability of the UE, and/or indicate another capability of the UE. For example, the channel processing capability of the UE may represent or indicate one or more of the following: whether the UE supports adjustment of a frequency domain density of M ports (for example, the M ports may be uniformly indicated, or different ports in the M ports may be separately indicated), whether the UE supports adjustment of a frequency domain density of at least one port group (for example, the at least one port group may be uniformly indicated, or different port groups in the at least one port group may be separately indicated, and the at least one port group may include the M ports), or a maximum value and/or a minimum value of a frequency domain density offset supported by the UE for each of the M ports. A maximum value and/or a minimum value of a frequency domain density offset supported by the UE for a port in the M ports may be understood as an adjustment range of a frequency domain density supported by the UE for the port, that is, a range in which the UE supports adjustment of the frequency domain density. For example, for a port #1, if a maximum value of a frequency domain density offset supported by the UE is +1RE/2RB and a minimum value of the frequency domain density offset supported by the UE is −2RE/2RB, it indicates that an adjustment range of a frequency domain density supported by the UE for the port #1 is [−2, 1] RE/2RB. Optionally, if the channel processing capability of the UE represents or indicates the maximum value and/or the minimum value of the frequency domain density offset supported by the UE for each of the M ports, the channel processing capability of the UE may no longer indicate whether the UE supports adjustment of the frequency domain density of the M ports or the frequency domain density of the at least one port group.

Optionally, the M ports are, for example, all or a part of ports corresponding to the UE. If the M ports are the part of ports corresponding to the UE, optionally, the capability information may indicate one or more of the following: whether the UE supports adjustment of frequency domain densities of all the ports corresponding to the UE, whether the UE supports adjustment of a frequency domain density of at least one port group (the at least one port group may include all the ports supported by the UE), or the maximum value and/or the minimum value of the frequency domain density offset supported by the UE for each port in all the ports supported by the UE.

Optionally, the M ports are, for example, all or a part of ports corresponding to the network device. If the M ports are a part of ports corresponding to the network device, optionally, the capability information may indicate one or more of the following: whether the UE supports adjustment of frequency domain densities of all ports corresponding to the network device, whether the UE supports adjusting a frequency domain density of at least one port group (the at least one port group may include all the ports supported by the network device), or a maximum value and/or a minimum value of a frequency domain density offset supported by the UE for each port in all the ports supported by the network device.

Alternatively, the UE may not send the capability information of the UE to the network device. Therefore, S301 is an optional step.

S302: The UE obtains first information. The first information may be used to determine a frequency domain density offset of a reference signal corresponding to the M ports, where M is a positive integer. The frequency domain density offset may be used to adjust a frequency domain density. For example, the frequency domain density offset may also be referred to as a frequency domain density adjustment amount, a frequency domain density offset, a frequency domain density correction amount, or the like. A name of the frequency domain density offset is not limited. A reference signal corresponding to a port is, for example, a reference signal received or sent through the port.

The UE may obtain the first information in different manners. For example, an optional manner in which the UE obtains the first information is that the network device sends the first information, and the UE receives the first information from the network device. In this manner, the network device may determine the first information. Therefore, it is flexible to implement. For another example, another optional manner in which the UE obtains the first information is that the UE obtains predefined or preconfigured first information. For example, if the first information is predefined by using a protocol, or may be preconfigured in the UE, the UE may obtain the first information according to the protocol or based on the preconfigured information. In addition, the UE may obtain the first information in another manner. This is not limited.

Optionally, the network device may be an entire architecture, or may be a distributed architecture. For example, the network device includes a CU and/or a DU, or includes one or more of a CU-CP, a CU-UP, or a DU. When the network device includes the DU, that the network device sends the first information to the UE may be specifically that the DU included in the network device sends the first information to the UE. Optionally, the network device including the DU may further include the CU; or the network device including the DU may further include the CU-CP and/or the CU-UP.

The UE may determine, based on the first information, the frequency domain density offset of the reference signal corresponding to the M ports. To achieve this objective, the first information may be implemented in different manners.

In some embodiments of the first information, the first information may indicate a mapping relationship between different MCSs and frequency domain density offsets of reference signals corresponding to different ports, or the first information may indicate a mapping relationship between an MCS, an index of each of N ports, and a frequency domain density offset of a reference signal corresponding to each port. In this case, the first information may be considered as configuration information. Optionally, the “port” in content indicated by the first information may also be replaced with “stream” or “transport layer (layer)”. This is not limited. N is a positive integer. For example, the N ports include the M ports. Optionally, the N ports may include all or a part of ports of each of one or more UEs, and/or include all or a part of ports of each of one or more network devices. The UE is one of the one or more UEs, and the network device is one of the one or more network devices.

For example, the mapping relationship may include a mapping relationship between at least one MCS interval, at least one frequency domain density offset, and indexes of the N ports. For example, in the mapping relationship, the index of each of the N ports corresponds to the at least one MCS interval; and in MCS intervals and frequency domain density offsets corresponding to one of the N ports, different MCS intervals correspond to a same frequency domain density offset or different frequency domain density offsets. If different MCS intervals correspond to different frequency domain density offsets, it may be considered that the MCS intervals are in a one-to-one correspondence with the frequency domain density offsets. In addition, in port indexes and frequency domain density offsets corresponding to one of the at least one MCS interval, different port indexes correspond to a same frequency domain density offset or different frequency domain density offsets. If different port indexes correspond to different frequency domain density offsets, it may be considered that the port indexes are in a one-to-one correspondence with the frequency domain density offsets. Optionally, an index of a port may represent a signal-to-noise ratio corresponding to the port. For example, an index of any port in the N ports may correspond to a signal-to-noise ratio interval, and signal-to-noise ratios included in the signal-to-noise ratio interval are all signal-to-noise ratios corresponding to the port. Signal-to-noise ratio intervals corresponding to different ports may have an intersection, or may not have an intersection. Alternatively, the index of the port may represent a ratio of a channel gain corresponding to the port to cell noise floor. For example, an index of any port in the N ports may correspond to a ratio interval, and ratios included in the ratio interval are all ratios corresponding to the port. Ratio intervals corresponding to different ports may have an intersection, or may not have an intersection.

For example, Table 1 is an example of the mapping relationship. The mapping relationship includes, for example, one or more items in Table 1. In Table 1, one port index, one MCS interval, and one frequency domain density offset may form one group of mapping relationships. It can be learned that Table 1 includes a plurality of groups of mapping relationships, and the mapping relationship indicated by the first information includes, for example, a part or all of the plurality of groups of mapping relationships shown in Table 1.

TABLE 1

| Frequency | | | | |
|---|---|---|---|---|
| domain density | MCS 0 to | MCS 5 to | MCS 11 to | MCS 20 to |
| offset | MCS 4 | MCS 10 | MCS 19 | MCS 27 |
| Port #1 | −2RE/2RB | −1RE/2RB | 0 (default value: | +1RE/2RB |
| | | | 1RE/1RB) | |
| Port #2 | −1RE/2RB | 0 (default value: | +1RE/2RB | +2RE/2RB |
| | | 1RE/1RB) | | |
| . . . | . . . | . . . | . . . | . . . |
| Port #24 | 0 (default value: | +1RE/2RB | +2RE/2RB | +3RE/2RB |
| | 1RE/1RB) | | | |

For example, in Table 1, each port (or each port index) may correspond to a plurality of MCS intervals. In each port, each of the plurality of MCS intervals corresponds to one frequency domain density offset. Different MCS intervals correspond to a same frequency domain density offset or different frequency domain density offsets. This may be a property met by any row in Table 1. For another example, in Table 1, each MCS interval may correspond to a plurality of ports (or correspond to a plurality of port indexes). In each MCS interval, each of the plurality of ports (or each port index) corresponds to one frequency domain density offset. Different ports correspond to a same frequency domain density offset or different frequency domain density offsets. This may be a property met by any column in Table 1.

In Table 1, 24 ports are used as an example. In Table 1, for the port #1, when a value of an MCS is in an interval greater than or equal to 0 and less than or equal to 4, a corresponding frequency domain density offset is −2RE/2RB. −2RE/2RB indicates that a frequency domain density offset of every two RBs is −2RE, and the frequency domain density offset may be subtracted from an initial frequency domain density to obtain an adjusted frequency domain density. Understanding of other mapping relationships in Table 1 is similar. If a frequency domain density offset is 0, it indicates that a frequency domain density does not need to be adjusted. For example, in Table 1, there are five MCS intervals corresponding to the port #1: MCS 0 to MCS 4, MCS 5 to MCS 10, MCS 11 to MCS 19, and MCS 20 to MCS 27. Frequency domain density offsets corresponding to the port #1 include −2RE/2RB, −1RE/2RB, 0, and +1RE/2RB. In the port #1, the frequency domain density offsets are in a one-to-one correspondence with the foregoing MCS intervals. It can be learned that, in the MCS intervals and the frequency domain density offsets corresponding to the port #1, different MCS intervals correspond to different frequency domain density offsets. For another example, in Table 1, port indexes corresponding to MCS 0 to MCS 4 include 1 to 24, and frequency domain density offsets corresponding to MCS 0 to MCS 4 include −2RE/2RB, −1RE/2RB, . . . , and 0. In the MCS 0 to MCS 4 interval, the frequency domain density offsets are in a one-to-one correspondence with the ports 1 to 24. It can be learned that, in the port indexes and the frequency domain density offsets that correspond to MCS 0 to MCS 4, different port indexes correspond to a same frequency domain density offset or different frequency domain density offsets (there may be a same frequency domain density offset in frequency domain density offsets that are not shown).

In another optional implementation of the first information, the first information may indicate a mapping relationship between different MCSs and frequency domain density offsets of reference signals corresponding to different port groups, or the first information may indicate a mapping relationship between one MCS, an index of each of the at least one port group, and a frequency domain density offset of a reference signal corresponding to each port group. In this case, the first information may be considered as configuration information. One port group may include one or more ports. For example, that the at least one port group includes the N ports may be understood as that all ports included in all port groups in the at least one port group include the N ports. The N ports may belong to one of the at least one port group, or may be distributed in a plurality of port groups in the at least one port group. Quantities of ports included in different port groups may be the same or may be different.

For example, the mapping relationship may include a mapping relationship between at least one MCS interval, at least one frequency domain density offset, and an index of at least one port group. For example, in the first information, the index of each of the at least one port group corresponds to the at least one MCS interval; and in MCS intervals and frequency domain density offsets corresponding to one of the at least one port group, different MCS intervals correspond to a same frequency domain density offset or different frequency domain density offsets. If different MCS intervals correspond to different frequency domain density offsets, it may also be considered that the MCS intervals are in a one-to-one correspondence with the frequency domain density offsets. In addition, in port group indexes and frequency domain density offsets corresponding to one of the at least one MCS interval, different port group indexes correspond to a same frequency domain density offset or different frequency domain density offsets. If different port group indexes correspond to different frequency domain density offsets, it may also be considered that the port group indexes are in a one-to-one correspondence with the frequency domain density offsets. Optionally, an index of a port group may represent a signal-to-noise ratio corresponding to the port group. For example, an index of any port group in the at least one port group may correspond to a signal-to-noise ratio interval, and signal-to-noise ratios included in the signal-to-noise ratio interval are all signal-to-noise ratios corresponding to the port group. Signal-to-noise ratio intervals corresponding to different port groups may have an intersection, or may not have an intersection. Alternatively, the index of the port group may represent a ratio of a channel gain corresponding to the port group to cell noise floor. For example, an index of any port group in the at least one port group may correspond to a ratio interval, and ratios included in the ratio interval are all ratios corresponding to the port group. Ratio intervals corresponding to different port groups may have an intersection, or may not have an intersection. A signal-to-noise ratio corresponding to any port included in one port group is within a signal-to-noise ratio interval corresponding to the port group. For example, the signal-to-noise ratio interval corresponding to the port group may be determined based on signal-to-noise ratios corresponding to a part or all of ports included in the port group. Similarly, a ratio of a channel gain corresponding to any port included in one port group to the cell noise floor is within a ratio interval corresponding to the port group. For example, the ratio interval corresponding to the port group may be determined based on ratios corresponding to a part or all of ports included in the port group.

For example, Table 2 is an example of the mapping relationship. The mapping relationship includes, for example, one or more items in Table 2. In Table 2, an index of one port group, one MCS interval, and one frequency domain density offset may form one group of mapping relationships. It can be learned that Table 2 includes a plurality of mapping relationships, and the mapping relationship indicated by the first information includes, for example, a part or all of the plurality of mapping relationships shown in Table 2.

TABLE 2

| Frequency | | | | |
|---|---|---|---|---|
| domain density | MCS 0 to | MCS 5 to | MCS 11 to | MCS 20 to |
| offset | MCS 4 | MCS 10 | MCS 19 | MCS 27 |
| Port group #1 | −2RE/2RB | −1RE/2RB | 0 (default value: | +1RE/2RB |
| | | | 1RE/1RB) | |
| Port group #2 | −1RE/2RB | 0 (default value: | +1RE/2RB | +2RE/2RB |
| | | 1RE/1RB) | | |
| . . . | . . . | . . . | . . . | . . . |
| Port group #12 | 0 (default value: | +1RE/2RB | +2RE/2RB | +3RE/2RB |
| | 1RE/1RB) | | | |

For example, in Table 2, each port group (or each port group index) may correspond to a plurality of MCS intervals. In each port group, each of the plurality of MCS intervals corresponds to one frequency domain density offset. Different MCS intervals correspond to a same frequency domain density offset or different frequency domain density offsets. This may be a property met by any row in Table 2. For another example, in Table 2, each MCS interval may correspond to a plurality of port groups (or correspond to a plurality of port group indexes). In each MCS interval, each of the plurality of port groups (or each port group index) corresponds to one frequency domain density offset. Different port groups correspond to a same frequency domain density offset or different frequency domain density offsets. This may be a property met by any column in Table 2.

In Table 2, 12 port groups are used as an example. For the port group #1, when a value of an MCS is in an interval greater than or equal to 0 and less than or equal to 4, a corresponding frequency domain density offset is −2RE/2RB. Understanding of other mapping relationships in Table 2 is similar. For example, in Table 2, there are five MCS intervals corresponding to the port group #1: MCS 0 to MCS 4, MCS 5 to MCS 10, MCS 11 to MCS 19, and MCS 20 to MCS 27. Frequency domain density offsets corresponding to the port group #1 include −2RE/2RB, −1RE/2RB, 0, and +1RE/2RB. In the port group #1, the frequency domain density offsets are in a one-to-one correspondence with the foregoing MCS intervals. It can be learned that, in the MCS intervals and the frequency domain density offsets corresponding to the port group #1, different MCS intervals correspond to different frequency domain density offsets. For another example, in Table 2, port group indexes corresponding to MCS 0 to MCS 4 include 1 to 12, and frequency domain density offsets corresponding to MCS 0 to MCS 4 include −2RE/2RB, −1RE/2RB, . . . , and 0. In an MCS 0 to MCS 4 interval, the frequency domain density offsets are in a one-to-one correspondence with the port groups 1 to 12. It can be learned that, in the port group indexes and the frequency domain density offsets that correspond to MCS 0 to MCS 4, different port group indexes correspond to a same frequency domain density offset or different frequency domain density offsets (there may be a same frequency domain density offset in frequency domain density offsets that are not shown).

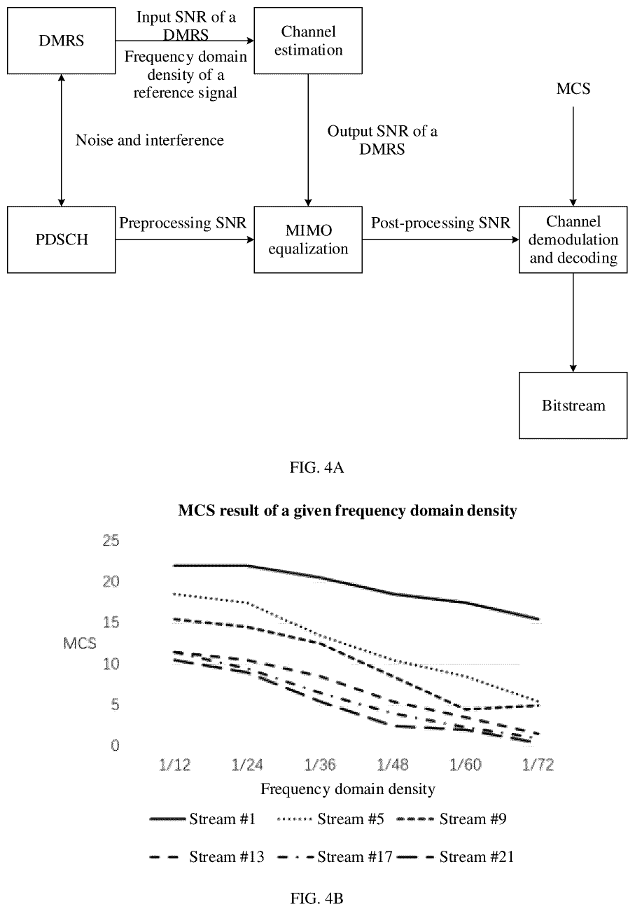

In other words, in some embodiments of this application, it is considered that an MCS is affected by channel estimation performance, or it is understood that, when an MCS is given, channel estimation performance affects a transmission success rate. Therefore, in some embodiments of this application, an association is established between the MCS and a frequency domain density (or a frequency domain density offset) of a reference signal, so that an appropriate frequency domain density can be determined by using the MCS. For example, FIG. 4A is a diagram of a relationship between a frequency domain density of a reference signal and an MCS in a given port. In FIG. 4A, an example in which the reference signal is a DMRS is used. For example, a receiver (UE or a network device) of the DMRS performs channel estimation based on the received DMRS, and a channel estimation result is affected by parameters such as an input signal-to-noise ratio (SNR) of the DMRS and a frequency domain density of the DMRS. After channel estimation, the receiver performs MIMO equalization processing based on the channel estimation result and a PDSCH, and a result of MIMO equalization is affected by parameters such as an output SNR of the DMRS and a pre-processing (pre) SINR. For example, if the SNR is poor, MIMO equalization effect may be poor. Consequently, an output post-processing (post) signal to interference plus noise ratio (SINR) is low, so that an MCS used for channel demodulation or decoding is also low. It can be inferred that the MCS is associated with the frequency domain density of the DMRS. Therefore, in some embodiments of this application, an association is established between the MCS and the frequency domain density of the reference signal, so that a corresponding frequency domain density can be determined by using an expected MCS, to improve channel estimation accuracy, and improve channel demodulation or decoding performance.

Refer to FIG. 4B. FIG. 4B is a diagram of a maximum MCS changing with a frequency domain density of a reference signal when a port or a port group is given. In FIG. 4B, an example in which the reference signal is also a DMRS is used. In addition, a “stream” in FIG. 4B may correspond to a port or a port group. For example, one stream corresponds to one port or one port group. In FIG. 4B, a horizontal axis represents a frequency domain density of a reference signal, and a vertical axis represents an MCS. It can be learned from FIG. 4B that, as the frequency domain density decreases, the MCS also gradually decreases. For example, for MCS 17 to MCS 25, a corresponding frequency domain density is about 1/12 to 1/60, that is, the frequency domain density can be adjusted. If the MCS is less than or equal to 17, a corresponding frequency domain density is small. Simulation parameters in FIG. 4B include: A channel model is a cluster delay line (CDL)-A, a multipath delay spread is 100 ns, a user moving speed is 3 km/h, EsN0=25 dB, a subcarrier spacing is 30 kHz, single-user (SU)-MIMO is 24 layers, and the like. EsN0 represents noise and interference.

According to FIG. 4A and/or FIG. 4B, a mapping relationship between the MCS and the frequency domain density (or the frequency domain density offset) of the reference signal may be obtained, for example, represented as:

$$MCS = f ( stream index or port index , frequency domain density of a reference signal corresponding to a port ) \qquad ( formula 1 )$$

Optionally, for a port, a larger MCS corresponding to the port indicates a larger frequency domain density of a reference signal corresponding to the port or a larger frequency domain density offset of the reference signal corresponding to the port; and/or for a port, a smaller MCS corresponding to the port indicates a smaller frequency domain density of a reference signal corresponding to the port or a smaller frequency domain density offset of the reference signal corresponding to the port. The port is, for example, a specific port in the N ports, or any one of the N ports. For example, for a port with a large gain (for example, referred to as a top (TOP) port), when an SNR condition is sufficient, a frequency domain density of a reference signal corresponding to the port may be appropriately reduced, to reduce overheads of the reference signal. For another example, for a port with a small gain (for example, referred to as a bottom (bottom) port), when a frequency domain resource condition is sufficient, a frequency domain density corresponding to the port may be appropriately increased, to improve channel estimation accuracy of the port.

For example, Table 3 is an example of the mapping relationship between the frequency domain density and the MCS. A “stream” in Table 3 may correspond to a port or a port group. For example, a “stream #1” may be replaced with a “port #1” or a “port group #1”.

TABLE 3

| Frequency | | | | | | |
|---|---|---|---|---|---|---|
| domain | Stream | Stream | Stream | Stream | Stream | Stream |
| density | #1 | #5 | #9 | #13 | #17 | #21 |
| 1/12 | 22.0 | 18.5 | 15.5 | 11.5 | 11.5 | 10.5 |
| 1/24 | 22.0 | 17.5 | 14.5 | 10.5 | 9.5 | 9.0 |
| 1/36 | 20.5 | 13.5 | 12.5 | 8.5 | 6.5 | 5.5 |
| 1/48 | 18.5 | 10.5 | 8.5 | 5.5 | 4.0 | 2.5 |
| 1/60 | 17.5 | 8.5 | 4.5 | 3.5 | 2.3 | 2.0 |
| 1/72 | 15.5 | 5.5 | 5.0 | 1.5 | 1.0 | 0.4 |

For example, in Table 3, each stream (or each stream index) may correspond to a plurality of frequency domain densities. For each stream, each of the plurality of frequency domain densities corresponds to one MCS. Different frequency domain densities correspond to a same MCS or different MCSs. This may be a property met by any row in Table 3. For another example, in Table 3, each frequency domain density may correspond to a plurality of streams (or correspond to a plurality of stream indexes). For each frequency domain density, each of the plurality of streams (or each stream index) corresponds to one MCS. Different streams correspond to a same MCS or different MCSs. This may be a property met by any column in Table 3.

For example, in Table 3, when the frequency domain density of the reference signal is 1/12, an average MCS of the stream #1 is 22.0, and an average MCS of the stream #5 is 18.5, and so on.

Optionally, in the mapping relationship indicated by the first information, a sum of frequency domain density offsets of reference signal corresponding to the M ports may be less than or equal to a first threshold, or a sum of frequency domain density offsets of reference signals corresponding to the N ports may be less than or equal to the first threshold; and/or in the mapping relationship indicated by the first information, a sum of frequency domain density offsets of reference signals corresponding to the at least one port group may be less than or equal to the first threshold, or a sum of frequency domain density offsets of reference signals corresponding to a port group in which the M ports are located may be less than or equal to the first threshold. The first threshold may be predefined by using a protocol, or may be configured by the network device or the UE, or may be preconfigured in the network device and the UE. Alternatively, the network device and the UE may not sense the first threshold. For example, the first threshold is greater than or equal to 0. For example, if the sum of the frequency domain density offsets of the reference signals corresponding to the N ports is 0, it indicates that overall overheads of the reference signal do not change before and after frequency domain density adjustment. When the overheads of the reference signal remain unchanged, channel estimation accuracy can be improved in some embodiments of this application.

Optionally, a difference between a first frequency domain density and a second frequency domain density may be less than or equal to a second threshold, or an absolute value of a difference between the first frequency domain density and the second frequency domain density may be less than or equal to the second threshold. The first frequency domain density is a sum of frequency domain densities corresponding to the M ports determined based on the frequency domain density offsets of the reference signals corresponding to the N ports, or a sum of frequency domain densities corresponding to the M ports determined based on the frequency domain density offset of the reference signal corresponding to the M ports. The second frequency domain density is a sum of initial frequency domain densities corresponding to the N ports, or a sum of initial frequency domain densities corresponding to the M ports. Alternatively, the second frequency domain density is a sum of frequency domain densities corresponding to the M ports that are not determined based on the frequency domain density offset of the reference signal corresponding to the M ports. Alternatively, the second frequency domain density is a sum of frequency domain densities corresponding to the N ports that are not determined based on the frequency domain density offsets of the reference signals corresponding to the N ports. It may be understood that the first frequency domain density is a frequency domain density after the M ports are adjusted, and the second frequency domain density is a frequency domain density before the M ports are adjusted; or the first frequency domain density is a frequency domain density after the N ports are adjusted, and the second frequency domain density is a frequency domain density before the N ports are adjusted. The second threshold may be predefined by using a protocol, or may be configured by the network device or the UE, or may be preconfigured in the network device and the UE. Alternatively, the network device and the UE may not sense the second threshold. For example, the second threshold is greater than or equal to 0. For example, if a difference between the first frequency domain density and the second frequency domain density is 0, it indicates that overall overheads of the reference signal do not change before and after the frequency domain density adjustment. When the overheads of the reference signal remain unchanged, channel estimation accuracy can be improved in some embodiments of this application.

For another example, if the first frequency domain density is less than the second frequency domain density, after the frequency domain density of the reference signal corresponding to the M ports is adjusted, an overall frequency domain density is reduced. Therefore, a part of resources (for example, referred to as a first reference signal resource, and may be understood as a resource corresponding to an absolute value of a difference between the first frequency domain density and the second frequency domain density) that are originally used to send the reference signal are no longer used to send the reference signal. In this case, the UE may send or receive data by using the first reference signal resource, to improve resource utilization. Optionally, in this case, the first frequency domain density is a sum of frequency domain densities corresponding to the M ports determined based on the frequency domain density offset of the reference signal corresponding to the M ports, and the second frequency domain density is a sum of frequency domain densities corresponding to the M ports that is not determined based on the frequency domain density offset of the reference signal corresponding to the M ports.

Regardless of whether the first information indicates the mapping relationship between the different MCSs and the frequency domain density offsets of the reference signals corresponding to the different ports, or indicates the mapping relationship between the different MCSs and the frequency domain density offsets of the reference signals corresponding to different port groups, it may be considered that the first information is implicitly indicated. After obtaining the first information, the UE further needs to determine the frequency domain density offset with reference to other information, or determine a final frequency domain density.

Optionally, the method may further include S303: The network device sends downlink control information (DCI). Correspondingly, the UE receives the DCI from the network device. The DCI may indicate one or more MCSs, and the one or more MCSs correspond to the M ports. For example, the DCI indicates an association relationship between indexes of the M ports and the one or more MCSs. Alternatively, the DCI may indicate the M ports, and the M ports correspond to the one or more MCSs. For example, the DCI indicates an association relationship between the indexes of the M ports and the one or more MCSs. A quantity of the one or more MCSs may be less than or equal to M. For example, if the quantity of the one or more MCSs is equal to M, the one or more MCSs may be in a one-to-one correspondence with the M ports; or if the quantity of the one or more MCSs is less than M, a part of MCSs in the one or more MCSs may correspond to a plurality of ports in the M ports, that is, a plurality of ports correspond to a same MCS. For example, the DCI may schedule PDSCHs corresponding to the M ports, and PDSCHs of different ports may respectively correspond to respective MCSs. Therefore, the DCI may indicate a plurality of MCSs corresponding to the PDSCHs corresponding to the M ports. The UE may determine, with reference to the mapping relationship indicated by the first information and the one or more MCSs, the frequency domain density offsets of the reference signals corresponding to the part of or all of the M ports. For example, the mapping relationship indicated by the first information is shown in Table 1, and the DCI indicates that the MCS of the port #1 is the MCS 2. In this case, the UE may determine that the frequency domain density offset of the reference signal corresponding to the port #1 is −2RE/2RB.

For example, if the first information is sent by the network device, a sending manner is that the first information is included in the DCI, and S302 and S303 may be a same step; or even if the first information is sent by the network device, the first information may not be included in the DCI, but is sent by using another message (for example, a radio resource control (RRC) message or other DCI), and S302 and S303 are different steps. If S302 and S303 are different steps, S303 may occur before S302, or after S302, or simultaneously with S302.

Optionally, the network device may be an entire architecture, or may be a distributed architecture. For example, the network device includes a CU and/or a DU, or includes one or more of a CU-CP, a CU-UP, or a DU. When the network device includes the DU, that the network device sends the DCI to the UE may be specifically that the DU included in the network device sends the DCI to the UE. Optionally, the network device including the DU may further include the CU; or the network device including the DU may further include the CU-CP and/or the CU-UP.

In addition to the implicit indication manner described above, the first information may also be indicated explicitly.

In another optional implementation of the first information, the first information may indicate the frequency domain density offset of the reference signal corresponding to each of the M ports, or the first information may indicate the frequency domain density offset of the reference signal corresponding to each of the at least one port group. If the first information indicates the frequency domain density offset of the reference signal corresponding to the port group, the frequency domain density of all ports in the port group is adjusted based on the frequency domain density offset corresponding to the port group.

The network device may determine the frequency domain density offset of the reference signal corresponding to each of the M ports. For example, the network device may determine the frequency domain density offset of the reference signal corresponding to each port based on the foregoing mapping relationship between different MCSs and frequency domain density offsets of reference signals corresponding to different ports, and then indicate the frequency domain density offset to the UE by using the first information. Alternatively, the network device may determine the frequency domain density offset of the reference signal corresponding to each of the at least one port group. For example, the network device may determine, based on the foregoing mapping relationship between different MCSs and frequency domain density offsets of reference signals corresponding to different port groups, the frequency domain density offset of the reference signal corresponding to each port group, and then indicate the frequency domain density offset to the UE by using the first information. Therefore, the UE does not need to perform a processing process of determining the frequency domain density offset based on the mapping relationship, thereby helping simplify implementation of the UE.

In another optional implementation of the first information, the first information may indicate the frequency domain density of the reference signal corresponding to each of the M ports, or the first information may indicate the frequency domain density of the reference signal corresponding to each of the at least one port group. If the first information indicates the frequency domain density of the reference signal corresponding to the port group, the frequency domain density corresponding to the port group is used for all ports in the port group.

The network device may determine the frequency domain density offset of the reference signal corresponding to each of the M ports. For example, the network device may determine, based on the foregoing mapping relationship between the different MCSs and the frequency domain density offsets of the reference signals corresponding to the different ports, the frequency domain density offset of the reference signal corresponding to each port. In addition, the network device may determine, based on an initial frequency domain density of the reference signal corresponding to each of the M ports and the frequency domain density offset of the reference signal corresponding to each port, the frequency domain density of the reference signal corresponding to the port. The frequency domain density is a result obtained after the initial frequency domain density is adjusted based on the frequency domain density offset. The network device then indicates the frequency domain density offset to the UE by using the first information. Alternatively, the network device may determine the frequency domain density offset of the reference signal corresponding to each of the at least one port group. For example, the network device may determine, based on the foregoing mapping relationship between the different MCSs and the frequency domain density offsets of the reference signals corresponding to the different port groups, the frequency domain density offset of the reference signal corresponding to each port group. In addition, the network device may determine, based on the initial frequency domain density of the reference signal corresponding to each of the at least one port group and the frequency domain density offset of the reference signal corresponding to each port group, the frequency domain density of the reference signal corresponding to the port group, and then indicate the frequency domain density offset to the UE by using the first information. The initial frequency domain density of the reference signal corresponding to the port group may be a frequency domain density of a reference signal corresponding to any port in the port group. For example, the frequency domain density of the reference signal corresponding to the M ports are equal. In other words, for different ports in the M ports, initial frequency domain densities corresponding to the different ports may be equal. By using the first information, the UE does not need to perform a processing process of determining the frequency domain density offset based on the mapping relationship, and even the UE does not need to sense the frequency domain density offset, but may directly obtain the final frequency domain density, thereby helping simplify implementation of the UE.

When the first information uses the explicit indication manner described above, optionally, the method may also include the foregoing S303.

Optionally, if the first information is sent by the network device to the UE, and the UE sends capability information to the network device, the network device may determine the first information with reference to the capability information of the UE. For example, if the capability information of the UE indicates that the UE does not support adjustment of the frequency domain density for the M ports, the network device may not need to send the first information to the UE, and the UE does not need to adjust the frequency domain density, but directly applies initial a frequency domain density of the reference signal corresponding to the M ports. For another example, if the capability information of the UE indicates that the UE does not support adjustment of the frequency domain densities for a part of ports in the M ports, the first information sent by the network device may not indicate frequency domain density offsets for these ports that do not support adjustment of the frequency domain density, or the indicated frequency domain density offset is 0. For another example, if the capability information of the UE indicates a maximum value and/or a minimum value of the frequency domain density offset of the reference signal corresponding to the port of the UE, the frequency domain density offset of the reference signal corresponding to the port that is determined based on the first information sent by the network device may be less than or equal to the maximum value, and/or greater than or equal to the minimum value.

S304: The UE determines, based on the frequency domain density offset of the reference signal corresponding to the M ports, the frequency domain density of the reference signal corresponding to the M ports.

For example, the UE determines, based on the frequency domain density offset of the reference signal corresponding to each of the M ports, the frequency domain density of the reference signal corresponding to each of the M ports. Alternatively, the UE determines, based on the frequency domain density offset of the reference signal corresponding to each of the at least one port group, the frequency domain density of the reference signal corresponding to each of the at least one port group.

Optionally, the first information indicates, for example, the mapping relationship between the different MCSs and the frequency domain density offsets of the reference signals corresponding to the different ports, or indicates the mapping relationship between the different MCSs and the frequency domain density offsets of the reference signals corresponding to the different port groups, or indicates the frequency domain density offset corresponding to each of the M ports. In this case, the UE may determine, based on the frequency domain density offset of the reference signal corresponding to each of the M ports and the initial frequency domain density of the reference signal corresponding to each of the M ports, the frequency domain density of the reference signal corresponding to the M ports.

For example, the DCI in S303 further indicates a DMRS pattern (pattern), and the UE may determine, based on the DMRS pattern, the initial frequency domain density of the reference signal corresponding to each of the M ports. Alternatively, the DCI does not indicate the DMRS pattern, and the UE may determine the initial frequency domain density of the reference signal corresponding to each of the M ports based on other information. For example, the other information includes one or more of the following: a protocol-predefined default frequency domain density value of the reference signal corresponding to each of the M ports, an initial frequency domain density of the reference signal corresponding to each of the M ports preconfigured in the UE and the network device, or a frequency domain density of the reference signal corresponding to each of the M ports configured by higher layer signaling (for example, RRC layer signaling or signaling of another protocol layer) from the network device. Alternatively, the DCI does not indicate the DMRS pattern, and the UE cannot determine the initial frequency domain density of the reference signal corresponding to each of the M ports based on the other information. In this case, the UE may not need to adjust the frequency domain densities of the M ports. For example, Table 4 is an example of an initial frequency domain density of a reference signal corresponding to a port.

TABLE 4

| Port index | Initial frequency domain density |
|---|---|
| Port #1 | 1RE/1RB |
| Port #2 | 1RE/1RB |
| . . . | . . . |
| Port #24 | 1RE/1RB |

In Table 4, 24 ports are used as an example. In Table 4, an initial frequency domain density of each port is 1RE/1RB. For example, the M ports include a part of or all of the ports shown in Table 4. For example, the first information is Table 1, and the initial frequency domain density of the reference signal corresponding to the M ports is Table 4. For the frequency domain density of the reference signal corresponding to the M ports determined by the UE, refer to Table 5.

TABLE 5

| Port index | Frequency domain density |
|---|---|
| Port #1 | 1RE/2RB |
| Port #2 | 1RE/2RB |
| . . . | . . . |
| Port #24 | 2RE/1RB |

As described above, if the first information indicates the mapping relationship between the different MCSs and the frequency domain density offset of the reference signals corresponding to different ports, or indicates the mapping relationship between the different MCSs and the frequency domain density offset of the reference signals corresponding to different port groups, or indicates the frequency domain density offset corresponding to each of the M ports, the UE may perform S304. Alternatively, if the first information indicates the frequency domain density of the reference signal corresponding to each of the M ports, it is equivalent to that the first information directly indicates the adjusted frequency domain density. In this case, the UE may not need to perform S304, that is, the UE obtains the first information, and can determine the frequency domain density of the reference signal corresponding to each of the M ports.

S305: The network device determines, based on the frequency domain density offset of the reference signal corresponding to the M ports, the frequency domain density of the reference signal corresponding to the M ports.

For example, if the first information is predefined in a protocol or preconfigured in the network device, the network device may determine, based on the first information, the frequency domain density offset of the reference signal corresponding to the M ports, and determine, based on the frequency domain density offset of the reference signal corresponding to the M ports, the frequency domain density of the reference signal corresponding to the M ports. Alternatively, the network device may directly determine, based on the first information, the frequency domain density of the reference signal corresponding to the M ports (in this case, S305 does not need to be performed). For the foregoing determining manner, refer to the foregoing description of the determining process of the UE.

Alternatively, if the first information is sent by the network device to the UE, the network device may first determine the frequency domain density offset of the reference signal corresponding to the M ports, and determine, based on the frequency domain density offset of the reference signal corresponding to the M ports, the frequency domain density of the reference signal corresponding to the M ports. For example, the network device first obtains the mapping relationship (the mapping relationship between the different MCSs and the frequency domain density offsets of the reference signals corresponding to the different ports, or the mapping relationship between the different MCSs and the frequency domain density offsets of the reference signals corresponding to the different port groups). For example, the network device generates the mapping relationship, or the mapping relationship is preconfigured in the network device. After obtaining the mapping relationship, the network device may determine, based on the mapping relationship, the frequency domain density offset of the reference signal corresponding to each of the M ports. For example, the network device may determine, with reference to the plurality of MCSs (that is, the one or more MCSs indicated by the DCI) described above, the frequency domain density offset of the reference signal corresponding to each of the M ports, and determine the frequency domain density of the reference signal corresponding to each of the M ports based on the frequency domain density offset of the reference signal corresponding to each of the M ports. For a determining manner, refer to the description of the determining process of the UE in S304. The first information sent by the network device to the UE may directly indicate the mapping relationship, or indicate the frequency domain density offset or the frequency domain density of the reference signal corresponding to each of the M ports.

S306: The UE sends the reference signal based on the frequency domain density of the reference signal corresponding to the M ports. Correspondingly, the network device receives the reference signal based on the frequency domain density of the reference signal corresponding to the M ports. Alternatively, the network device sends the reference signal based on the frequency domain density of the reference signal corresponding to the M ports, and correspondingly, the UE receives the reference signal based on the frequency domain density of the reference signal corresponding to the M ports.

Optionally, the network device may be an entire architecture, or may be a distributed architecture. For example, the network device includes a CU and/or a DU, or includes one or more of a CU-CP, a CU-UP, or a DU. When the network device includes the DU, that the network device receives the reference signal from UE may be specifically that the DU included in the network device receives the reference signal from the UE. Similarly, when the network device includes the DU, that the network device sends the reference signal to the UE may be specifically that the DU included in the network device sends the reference signal to the UE. Optionally, the network device including the DU may further include the CU; or the network device including the DU may further include the CU-CP and/or the CU-UP.

The UE and the network device need to send and receive the reference signal based on the frequency domain density of the reference signal corresponding to the M ports, and further need to determine a frequency domain resource location to which the reference signal corresponding to each of the M ports is mapped. It may be understood that, in some embodiments of this application, the frequency domain density of the reference signal corresponding to the port is adjusted. Therefore, for one port, a frequency domain resource location to which a reference signal sent or received by using the port is mapped may also change. Therefore, the UE and the network device may determine the frequency domain resource location to which the reference signal sent or received by using the port is mapped, so that the reference signal can be sent or received by using the port.

Optionally, the second information may indicate the frequency domain resource location to which the reference signal corresponding to each of the M ports is mapped. For example, if the second information is predefined in a protocol, both the UE and the network device may determine, based on the second information predefined in the protocol, the frequency domain resource location to which the reference signal corresponding to each of the M ports is mapped; or if the second information is sent by the network device to the UE, the network device may determine the frequency domain resource location to which the reference signal corresponding to each of the M ports is mapped, and then indicate the frequency domain resource location to the UE by using the second information. The second information and the foregoing first information may be same information, or may be different information.

Alternatively, the frequency domain resource location to which the reference signal corresponding to each of the M ports is mapped is predefined. For example, for each possible frequency domain density, the protocol may predefine a frequency domain resource location to which a reference signal in the frequency domain density is mapped. In this case, the UE or the network device may determine, based on the protocol, the frequency domain resource location to which the reference signal corresponding to the port is mapped, provided that the UE or the network device determines the frequency domain density of the reference signal corresponding to the port.

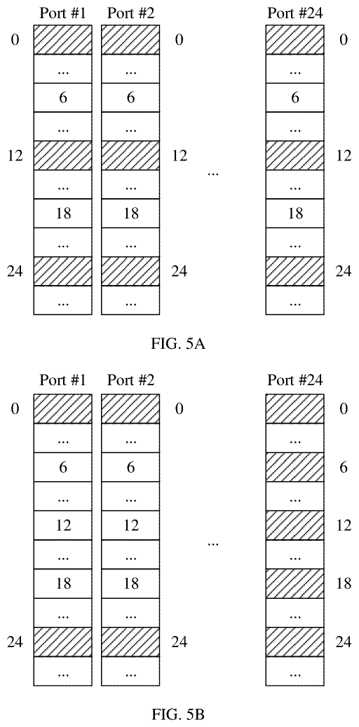

For example, refer to FIG. 5A and FIG. 5B. FIG. 5A is a frequency domain resource location to which a reference signal corresponding to M ports is mapped when a frequency domain density of the reference signal corresponding to the M ports is an initial frequency domain density. FIG. 5B is a frequency domain resource location to which the reference signal corresponding to the M ports is mapped when the frequency domain density of the reference signal corresponding to the M ports is an adjusted frequency domain density. In FIG. 5A and FIG. 5B, M=24 is used as an example. A horizontal axis represents time, a vertical axis represents frequency, and a vertical block represents a subcarrier. In FIG. 5A and FIG. 5B, a shadow block represents a frequency domain resource location to which a reference signal is mapped. For example, in FIG. 5A, frequency domain resources to which reference signals corresponding to each of the port 1 to the port 24 are mapped are subcarriers 0, 12, 24, and the like. In FIG. 5B, frequency domain resources to which reference signals corresponding to each port such as the port 1 and the port 2 are mapped are subcarriers 0, 24, and the like, and frequency domain resources to which a reference signal corresponding to the port 24 is mapped are subcarriers 0, 6, 12, 18, 24, and the like.

After the frequency domain resource location to which the reference signal corresponding to each of the M ports is mapped is determined, the UE and the network device may receive and send the reference signal at the frequency domain resource location to which the reference signal corresponding to each of the M ports is mapped.

Optionally, the method may further include S307: The reference signal receiver performs channel estimation based on the received reference signal. For example, if the reference signal is a DMRS, the reference signal receiver may perform channel estimation based on the DMRS. The reference signal receiver is, for example, UE or a network device. In FIG. 3, the UE is used as an example.

For example, the UE may perform channel estimation by using a Wiener (Wiener) filter, or the UE may perform channel estimation in another manner. This is not specifically limited. The following uses the Wiener filter as an example to describe a channel estimation process of the UE.

After receiving the DMRS, the UE may determine information about a downlink channel based on the DMRS, and process the information about the downlink channel by using the Wiener filter, to obtain a channel estimation result. The channel estimation result may represent channel information on a resource that does not carry the DMRS, for example, represent PDSCH information. The PDSCH is, for example, a PDSCH scheduled by using the DCI in S302.

For example, W_{d} may be obtained by using the Wiener filter, and the channel estimation result may be obtained based on W_{d}. W_{d} may represent a port group. For example, W_{d} meets the following relationship:

$${W}_{d} = {{R}_{H {H}_{p}} ( {R}_{{H}_{p} {H}_{p}} + \frac{1}{S N R} {I}_{p} )}^{- 1} \qquad ( formula 2 )$$

In formula 2, R_{H}_{ₚ}_{H}_{ₚ} represents a covariance matrix of a channel matrix at a time-frequency resource location at which a reference signal is located, Iₚ represents an identity matrix with a same dimension as R_{H}_{ₚ}_{H}_{ₚ}, and the SNR represents an estimated value of a signal-to-noise ratio corresponding to the downlink channel. In addition, in formula 2, for example, R_{HH}_{ₚ} meets the following relationship:

$${R}_{Ψ {Ψ}_{dmrs}^{H}} ( n , m ) = {R}_{{P}_{τ}} ( f ) {\vert}_{f = ( n - m ) \cdot Δ f} \qquad ( formula 3 )$$

$${R}_{Ψ {Ψ}_{dmrs}^{H}} ( n , m )$$

in formula 3 and R_{HH}_{ₚ} in formula 2 are a same parameter, n indicates an n^{th} subcarrier or frequency domain location, and m indicates an m^{th} subcarrier or frequency domain location.

$${R}_{Ψ {Ψ}_{dmrs}^{H}} ( n , m )$$

or R_{HH}_{ₚ} presents a filtering coefficient of the Wiener filter.

In formula 3, Rₚ_{_{τ}}(f) represents the delay frequency domain autocorrelation function, and Rₚ_{_{τ}}(f) may meet the following relationship:

$${R}_{p} ( f ) = FFT \{ {R}_{p} ( τ ) \} \qquad ( formula 4 )$$

FFT represents fast Fourier transform (fast fourier transform, FFT).

In Formula 4, Rₚ(τ) represents a delay-domain power spectrum, and Rₚ(τ) may meet the following relationship:

$${R}_{p} ( τ ) = \frac{1}{{τ}_{R M S}} \cdot {e}^{- \frac{\vert τ \vert}{{τ}_{R M S}}} , τ ∈ [ - {Δ}_{m} {τ}_{R M S} , ( {Δ}_{max} - {Δ}_{m} ) {τ}_{R M S} ] \qquad ( formula 5 )$$

In formula 5, τ_{RMS} represents a root mean square (RMS) of a multipath delay τ, τ represents the multipath delay, Δₘ represents a timing offset, and Δₘₐₓ represents a maximum value of the multipath delay offset.

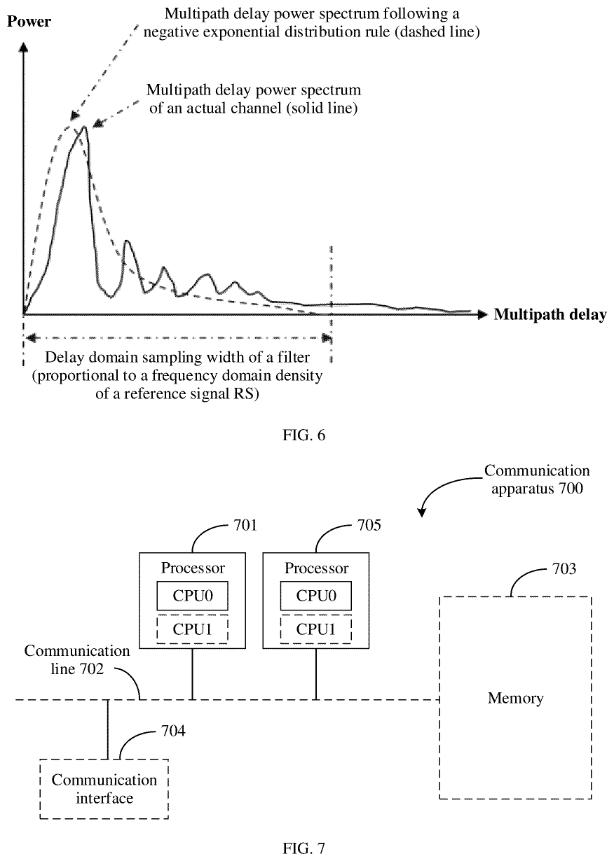

FIG. 6 is a diagram of a relationship between interpolation filtering performance of a Wiener filter and a frequency domain density of a reference signal. A horizontal axis in FIG. 6 represents a delay, and a vertical axis represents power. It can be learned from FIG. 6 that the frequency domain density of the reference signal affects a length of sampling time (or referred to as a sampling width, that is, a delay domain sampling width of a filter of a receiver (for example, UE)). For example, the length of the sampling time is directly proportional to a reciprocal of the frequency domain density of the reference signal. A larger frequency domain density indicates longer sampling time and more sampled signals. If an effective part (for example, a peak region shown in FIG. 6) of the signal can be collected within the sampling time, the obtained channel estimation result is good. However, if the sampling time is short, the effective part of the signal may not be collected or may not be completely collected, which is equivalent to that a part of the signal is lost, and the channel estimation result is poor. In some embodiments of this application, the frequency domain density of the reference signal corresponding to the port may be adjusted, so that interpolation filtering performance of the Wiener filter can be improved as much as possible.

In some embodiments of this application, the frequency domain density offset of the reference signal corresponding to the M ports may be determined based on the first information. For example, frequency domain density offsets of reference signals corresponding to different ports are the same or different. Therefore, frequency domain densities can be separately adjusted for reference signals corresponding to different ports, and an adjustment granularity is fine. The frequency domain density offset may be determined based on the MCS, which is equivalent to reflecting a requirement for a channel or reflecting a channel condition, so that the frequency domain density of the reference signal corresponding to each port can match the channel condition of the port and the like. When channel estimation is performed based on the DMRS, channel estimation may be performed based on the frequency domain density of the reference signal corresponding to the corresponding port. This is equivalent to that a channel condition corresponding to the port is considered in a channel estimation process, so that the channel estimation process can adapt to various different channel conditions, thereby helping improve channel estimation accuracy.

FIG. 7 is a diagram of a structure of a communication apparatus according to an embodiment of this application. The communication apparatus 700 may be the UE or the circuit system of the UE in the embodiment shown in FIG. 3, and is configured to implement the method corresponding to the UE in the foregoing method embodiments. Alternatively, the communication apparatus 700 may be the network device or the circuit system of the network device in the embodiment shown in FIG. 3, and is configured to implement the method corresponding to the network device in the foregoing method embodiments. For example, the circuit system is a chip system.

The communication apparatus 700 includes at least one processor 701. The processor 701 may be configured to perform internal processing of the apparatus, to implement a specific control processing function. Optionally, the processor 701 includes instructions. Optionally, the processor 701 may store data. Optionally, different processors may be independent components, may be located at different physical locations, or may be located on different integrated circuits. Optionally, different processors may be integrated into one or more processors, for example, integrated into one or more integrated circuits.

Optionally, the communication apparatus 700 includes one or more memories 703, configured to store instructions. Optionally, the memory 703 may further store data. The processor and the memory may be separately disposed, or may be integrated together.

Optionally, the communication apparatus 700 includes a communication line 702 and at least one communication interface 704. Because the memory 703, the communication line 702, and the communication interface 704 are all optional, the memory 703, the communication line 702, and the communication interface 704 are all represented by dashed lines in FIG. 7. The communication interface 704 may include an input interface and/or an output interface. Alternatively, the communication interface 704 includes a transceiver, and the transceiver can implement a sending function and/or a receiving function.

Optionally, the communication apparatus 700 may further include a transceiver and/or an antenna. The transceiver may be configured to send information to another apparatus or receive information from another apparatus. The transceiver may be referred to as a transceiver machine, a transceiver circuit, an input/output interface, or the like, and is configured to implement a transceiver function of the communication apparatus 700 through the antenna. Optionally, the transceiver includes a transmitter (transmitter) and a receiver (receiver). For example, the transmitter may be configured to generate a radio frequency (radio frequency) signal based on a baseband signal, and the receiver may be configured to convert a radio frequency signal into a baseband signal.

The processor 701 may include a general-purpose central processing unit (CPU), a microprocessor, an application specific integrated circuit (ASIC), or one or more integrated circuits configured to control program execution of solutions of this application.

The communication line 702 may include a path, to transfer information between the foregoing components.

The communication interface 704 uses any transceiver-type apparatus, to communicate with another device or a communication network like the Ethernet, a radio access network (RAN), a wireless local area network (WLAN), or a wired access network.

The memory 703 may be a read-only memory (ROM), another type of static storage device that can store static information and instructions, a random access memory (RAM), or another type of dynamic storage device that can store information and instructions, or may be an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, and the like), a magnetic disk storage medium or another magnetic storage device, or any other medium that can be configured to carry or store expected program code in a form of an instruction structure or a data structure and that is accessible to a computer, but is not limited thereto. The memory 703 may exist independently and is connected to the processor 701 through the communication line 702. Alternatively, the memory 703 may be integrated with the processor 701.

The memory 703 is configured to store computer-executable instructions for performing the solutions in this application, and the processor 701 controls the execution. The processor 701 is configured to execute the computer-executable instructions stored in the memory 703, to implement the steps performed by the UE or the network device in the embodiment shown in FIG. 3.

Optionally, the computer-executable instructions in some embodiments of this application may also be referred to as application program code. This is not specifically limited in some embodiments of this application.

During specific implementation, in an embodiment, the processor 701 may include one or more CPUs, for example, a CPU 0 and a CPU 1 in FIG. 7.

During specific implementation, in an embodiment, the communication apparatus 700 may include a plurality of processors, for example, the processor 701 and a processor 705 shown in FIG. 7. Each of the processors may be a single-core (single-CPU) processor, or may be a multi-core (multi-CPU) processor. The processor herein may be one or more devices, circuits, and/or processing cores configured to process data (for example, computer program instructions).

When the apparatus shown in FIG. 7 is a chip, for example, a chip of the UE or a chip of the network device, the chip includes the processor 701 (which may further include the processor 705), the communication line 702, and the communication interface 704. Optionally, the chip may include the memory 703. Specifically, the communication interface 704 may be an input interface, a pin, a circuit, or the like. The memory 703 may be a register, a cache, or the like. The processor 701 and the processor 705 each may be a general-purpose CPU, a microprocessor, an ASIC, or one or more integrated circuits configured to control program execution of the communication method in any one of the foregoing embodiments.

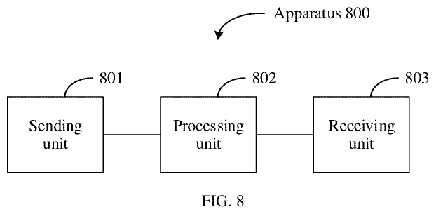

In embodiments of this application, the apparatus may be divided into functional modules based on the foregoing method examples. For example, each functional module may be obtained through division based on each corresponding function, or two or more functions may be integrated into one processing module. The integrated module may be implemented in a form of hardware, or may be implemented in a form of a software functional module. It should be noted that, in embodiments of this application, module division is an example, and is merely a logical function division. In actual implementation, another division manner may be used. For example, when the functional modules are obtained through division based on corresponding functions, FIG. 8 is a diagram of an apparatus. An apparatus 800 may be the UE or the network device in the foregoing method embodiments, or a chip in the UE or a chip in the network device. The apparatus 800 includes a transceiver unit and a processing unit 802. The transceiver unit may be configured to perform all sending steps and/or all receiving steps performed by the UE or the network device in the foregoing method embodiments. The processing unit 802 may be configured to perform all or some of remaining steps other than the sending step and the receiving step performed by the UE or the network device in the foregoing method embodiments. Optionally, the transceiver unit may be an integrated unit, and can implement a sending function and/or a receiving function. Alternatively, the transceiver unit may include a sending unit 801 and/or a receiving unit 803, the sending unit 801 is configured to implement a sending function, and the receiving unit 803 is configured to implement a receiving function.

It should be understood that the apparatus 800 may be configured to implement the steps performed by the UE or the network device in the communication method in the embodiments of this application. For related features, refer to the embodiment shown in FIG. 3. Details are not described herein again.

Optionally, functions/implementation processes of the sending unit 801, the receiving unit 803, and the processing unit 802 in FIG. 8 may be implemented by the processor 701 in FIG. 7 by invoking the computer-executable instructions stored in the memory 703. Alternatively, the function/the implementation process of the processing unit 802 in FIG. 8 may be implemented by the processor 701 in FIG. 7 by invoking the computer-executable instructions stored in the memory 703, and the functions/the implementation processes of the sending unit 801 and the receiving unit 803 in FIG. 8 may be implemented by the communication interface 704 in FIG. 7.

Optionally, when the apparatus 800 is a chip or a circuit, the functions/the implementation processes of the sending unit 801 and the receiving unit 803 may alternatively be implemented by a pin, a circuit, or the like.

This application further provides a computer-readable storage medium. The computer-readable storage medium stores a computer program or instructions. When the computer program or the instructions are run, the method performed by the UE or the network device in the foregoing method embodiment is implemented. In this way, the functions in the foregoing embodiments may be implemented in a form of a software functional unit and sold or used as an independent product. Based on such an understanding, the technical solutions of this application essentially, or the part contributing to technologies of some approaches, or a part of the technical solutions may be implemented in a form of a software product. The computer software product is stored in a storage medium, and includes several instructions for instructing a computer device (which may be a personal computer, a server, a network device, or the like) to perform all or a part of the steps of the methods described in embodiments of this application. The storage medium includes any medium that can store program code, such as a USB flash drive, a removable hard disk, a ROM, a RAM, a magnetic disk, or an optical disc.

This application further provides a computer program product. The computer program product includes computer program code. When the computer program code is run on a computer, the computer is enabled to perform the method performed by the UE or the network device in any one of the foregoing method embodiments.

An embodiment of this application further provides a processing apparatus, including a processor and an interface. The processor is configured to perform the method performed by the UE or the network device in any one of the foregoing method embodiments.

All or a part of the foregoing embodiments may be implemented by using software, hardware, firmware, or any combination thereof. When software is used to implement the embodiments, all or a part of the embodiments may be implemented in a form of a computer program product. The computer program product includes one or more computer instructions. When the computer program instructions are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

Various illustrative logical units and circuits described in embodiments of this application may implement or operate the described functions by using a general-purpose processor, a digital signal processor (DSP), an ASIC, a field-programmable gate array (FPGA) or another programmable logical apparatus, a discrete gate or transistor logic, a discrete hardware component, or a design of any combination thereof. The general-purpose processor may be a microprocessor. Optionally, the general-purpose processor may also be any processor, controller, microcontroller, or state machine. The processor may also be implemented by a combination of computing apparatuses, such as a digital signal processor and a microprocessor, multiple microprocessors, one or more microprocessors with a digital signal processor core, or any other similar configuration.

Steps of the methods or algorithms described in embodiments of this application may be directly embedded into hardware, a software unit executed by a processor, or a combination thereof. The software unit may be stored in a RAM, a flash memory, a ROM, an erasable programmable read-only memory (EPROM), an EEPROM, a register, a hard disk, a removable magnetic disk, a CD-ROM, or any other form of storage medium in the art. For example, the storage medium may connect to a processor so that the processor may read information from the storage medium and write information to the storage medium. Alternatively, the storage medium may be integrated into a processor. The processor and the storage medium may be disposed in an ASIC, and the ASIC may be disposed in a terminal device. Optionally, the processor and the storage medium may be disposed in different parts of a terminal device.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Mutual reference may be made to content in embodiments of this application. Unless otherwise specified or s logical conflict occurs, terms and/or descriptions in different embodiments are consistent and may be mutually referenced, and technical features in different embodiments may be combined into a new embodiment based on an internal logical relationship between the technical features.

It may be understood that, in embodiments of this application, the UE and/or the network device may perform a part or all of the steps in embodiments of this application. The steps or operations are merely examples. In embodiments of this application, other operations or variations of various operations may be further performed. In addition, the steps may be performed in a sequence different from that presented in embodiments of this application, and possibly, not all the operations in embodiments of this application need to be performed.

1. A communication method, comprising:
obtaining first information, wherein the first information is useable to determine a frequency domain density offset of a reference signal corresponding to M ports, and M is a positive integer;
determining, based on the frequency domain density offset of the reference signal corresponding to the M ports, a frequency domain density of the reference signal corresponding to the M ports; and
sending or receiving the reference signal based on the frequency domain density of the reference signal corresponding to the M ports.

2. The method according to claim 1, wherein obtaining the first information comprises:
receiving the first information from a network device; or
obtaining predefined first information.

3. The method according to claim 1, wherein
the first information is useable to indicate a mapping relationship between different modulation and coding schemes (MCSs) and frequency domain density offsets of reference signals corresponding to different ports.

4. The method according to claim 3, wherein
the mapping relationship comprises:
a mapping relationship between at least one MCS interval, at least one frequency domain density offset and indexes of N ports,
an index of each of the N ports corresponds to the at least one MCS interval,
in MCS intervals and frequency domain density offsets corresponding to one of the N ports, different MCS intervals correspond to a same frequency domain density offset or different frequency domain density offsets, and
in port indexes and frequency domain density offsets corresponding to one of the at least one MCS interval, different port indexes correspond to the same frequency domain density offset or the different frequency domain density offsets; and
the N ports comprise the M ports.

5. The method according to claim 1, wherein the first information is useable to indicate a mapping relationship between different modulation and coding schemes (MCSs) and frequency domain density offsets of reference signals corresponding to different port groups, and one port group comprises one or more ports in the M ports.

6. The method according to claim 5, wherein
the mapping relationship comprises:
a mapping relationship between at least one MCS interval, at least one frequency domain density offset and an index of at least one port group,
the index of of the at least one port group corresponds to the at least one MCS interval,
in MCS intervals and frequency domain density offsets corresponding to one of the at least one port group, different MCS intervals correspond to a same frequency domain density offset or different frequency domain density offsets, and
in port group indexes and frequency domain density offsets corresponding to one of the at least one MCS interval, different port group indexes correspond to the same frequency domain density offset or the different frequency domain density offsets; and
the at least one port group comprises N ports, and the N ports comprise the M ports.

7. The method according to claim 3, wherein
for a same port in N ports,
a larger MCS corresponding to the port is useable to indicate a larger frequency domain density offset of a reference signal corresponding to the port; or
a smaller MCS corresponding to the port is useable to indicate a smaller frequency domain density offset of the reference signal corresponding to the port; and
the N ports comprise the M ports.

8. The method according to claim 3, wherein a sum of frequency domain density offsets of reference signals corresponding to N ports is less than or equal to a first threshold, and the N ports comprise the M ports.

9. The method according to claim 3, further comprising:
receiving downlink control information from the network device, wherein the downlink control information is useable to indicate one or more MCSs, and the one or more MCSs correspond to the M ports; and
determining, based on the one or more MCSs and the mapping relationship indicated by the first information, frequency domain density offsets of reference signals corresponding to at least a part of the M ports.

10. The method according to claim 1, wherein
the first information is useable to indicate a frequency domain density offset of a reference signal corresponding to each of the M ports.

11. The method according to claim 1, wherein the first information is useable to further indicate
a frequency domain resource location to which the reference signal corresponding to each of the M ports is mapped; or
the frequency domain resource location to which the reference signal corresponding to each of the M ports is mapped is predefined.

12. The method according to claim 1, further comprising:
sending capability information of a terminal device to the network device, wherein
the capability information is useable to indicate whether the terminal device supports adjustment of frequency domain densities of the M ports, or
the capability information is useable to indicate a maximum value and a minimum value of a frequency domain density offset supported by each of the M ports.

13. The method according to claim 1, wherein
a difference between a first frequency domain density and a second frequency domain density is less than or equal to a second threshold,
the first frequency domain density is a sum of frequency domain densities corresponding to N ports and is determined based on the frequency domain density offsets of the reference signals corresponding to the N ports, and
the second frequency domain density is a sum of initial frequency domain densities corresponding to the N ports, and the N ports comprise the M ports.

14. The method according to claim 13, wherein in response to the first frequency domain density being less than the second frequency domain density, the method further comprises:
sending or receiving data by a first reference signal resource, wherein the first reference signal resource corresponds to a difference between the second frequency domain density and the first frequency domain density.

15. A communication method, comprising:
determining, based on a frequency domain density offset of a reference signal corresponding to M ports, a frequency domain density of the reference signal corresponding to the M ports, where M is a positive integer; and
receiving or sending the reference signal based on the frequency domain density of the reference signal corresponding to the M ports.

16. The method according to claim 15, further comprising:
obtaining predefined first information; or
sending the first information to a terminal device, wherein the first information is useable to determine the frequency domain density offset of the reference signal corresponding to the M ports.

17. The method according to claim 15, wherein
the first information is useable to indicate a mapping relationship between different modulation and coding schemes (MCSs) and frequency domain density offsets of reference signals corresponding to different ports.

18. The method according to claim 17, wherein
the mapping relationship comprises:
a mapping relationship between at least one MCS interval, at least one frequency domain density offset and indexes of N ports,
an index of each of the N ports corresponds to the at least one MCS interval,
in MCS intervals and frequency domain density offsets corresponding to one of the N ports, different MCS intervals correspond to a same frequency domain density offset or different frequency domain density offsets, and
in port indexes and frequency domain density offsets corresponding to one of the at least one MCS interval, different port indexes correspond to the same frequency domain density offset or the different frequency domain density offsets; and
the N ports comprise the M ports.

19. The method according to claim 15, wherein the first information is useable to indicate a mapping relationship between different modulation and coding schemes (MCSs) and frequency domain density offsets of reference signals corresponding to different port groups, and one port group comprises one or more ports in the M ports.

20. The method according to claim 19, wherein
the mapping relationship comprises:
a mapping relationship between at least one MCS interval, at least one frequency domain density offset and an index of at least one port group,
the index of the at least one port group corresponds to the at least one MCS interval,
in MCS intervals and frequency domain density offsets corresponding to one of the at least one port group, different MCS intervals correspond to a same frequency domain density offset or different frequency domain density offsets, and
in port group indexes and frequency domain density offsets corresponding to one of the at least one MCS interval, different port group indexes correspond to the same frequency domain density offset or the different frequency domain density offsets; and
the at least one port group comprises N ports, and the N ports comprise the M ports.
